(19) United States
(12) Patent Application Publication
(10) Pub. No.: US 2025/0292742 A1
(43) Pub. Date: Sep. 18, 2025

(54) DISPLAY DEVICE, DISPLAY CONTROL METHOD, AND DISPLAY CONTROL PROGRAM

(71) Applicant: SONY GROUP CORPORATION, TOKYO (JP)

(72) Inventors: YUJI NAKAHATA, TOKYO (JP); TOMOYA YANO, TOKYO (JP); MASA MIYAO, TOKYO (JP); HAJIME KIKUHARA, TOKYO (JP)

(21) Appl. No.: 18/862,217

(22) PCT Filed: Apr. 18, 2023
(86) PCT No.: PCT/JP2023/015418

§ 371 Date: Nov. 1, 2024

(30) Foreign Application Priority Data
May 9, 2022 (JP) 2022-077056

(51) Int. Cl. G09G 3/34; G02F 1/1335; G02F 1/13357

(52) U.S. Cl. CPC G09G 3/3413; G02F 1/133603; G02F 1/133607; G02F 1/133615; G09G 2320/0626; G09G 2354/00

(57) ABSTRACT

[Object] To provide a display device, a display control method, and a display control program that are capable of reducing power consumption without deteriorating the visibility of displayed video.

[Solving Means] A display device according to the present technology includes: a backlight (111); a light beam control unit (112); a display panel (113); a viewer position recognition unit; and a light emission control unit. The backlight (111) includes a plurality of light-emitting units. The light beam control unit (112) controls light that has entered from each of the plurality of light-emitting units to travel in a direction corresponding to a position of the light-emitting unit that is a light source and emits the light. The display panel (113) has a display surface (113a), the light that has entered from the light beam control unit being transmitted through the display panel (113a) and emitted from the display surface (113a). The viewer position recognition unit recognizes a viewer position that is a position of a viewer with respect to the display surface (113a). The light emission control unit controls each of the light-emitting units on a basis of a direction in which light from each of the light-emitting units as a light source is emitted from the display surface (113a) and the viewer position.

### TECHNICAL FIELD

The present technology relates to a display device that displays video, a display control method, and a display control program.

### BACKGROUND ART

Power saving is required for display devices such as television sets. One technology capable of achieving power saving is local dimming. In local dimming, the backlight of the display device is divided into a plurality of regions and the amount of light emitted from each region is adjusted in accordance with the brightness of displayed video. This reduces the amount of emitted light in dark portions of displayed video, making it possible to reduce power consumption. Further, a technology that identifies the portion of displayed video that a viewer is gazing at and reduces the amount of light emitted from portions other than the portion to reduce power consumption has also been developed (e.g., Patent Literature 1).

### CITATION LIST

### Patent Literature

Patent Literature 1: Japanese Patent Application Laid-open No. 2009-237210

### DISCLOSURE OF INVENTION

### Technical Problem

In the above-mentioned local dimming and the technology described in Patent Literature 1, it is possible to reduce power consumption without deteriorating the visibility of video. However, in the local dimming and the technology described in Patent Literature 1, light from displayed video is also emitted in a direction where there is no viewer, and this light is wasted light. Therefore, even in these technologies, there is still room for reducing power consumption.

In view of the circumstances as described above, it is an object of the present technology to provide a display device, a display control method, and a display control program that are capable of reducing power consumption without deteriorating the visibility of displayed video.

### Solution to Problem

In order to achieve the above-mentioned object, a display device according to an embodiment of the present technology includes: a backlight; a light beam control unit; a display panel; a viewer position recognition unit; and a light emission control unit.

The backlight includes a plurality of light-emitting units with light distribution control.

The light beam control unit controls light that has entered from each of the plurality of light-emitting units to travel in a direction corresponding to a position of the light-emitting unit that is a light source and emits the light.

The display panel has a display surface, the light that has entered from the light beam control unit being transmitted through the display panel and emitted from the display surface.

The viewer position recognition unit recognizes a viewer position that is a position of a viewer with respect to the display surface.

The light emission control unit controls each of the light-emitting units on a basis of a direction in which light from each of the light-emitting units as a light source is emitted from the display surface and the viewer position.

Here, the purpose of the light distribution control is to cause a group of light beams emitted from the light source to substantially enter a corresponding unit of the light beam control unit and make the luminance of the entire screen of a group of light beams that have been transmitted through the light beam control unit uniform at a viewer position. The means for achieving these can be to dispose a lens to be controlled for each light source to control uniformity and dispose a different lens for each unit such that it fits into each unit. Further, the two purposes may also be provided to a lens to be disposed in each light source.

The light emission control unit may cause a light-emitting unit that is a light source of light emitted from the display surface toward the viewer position, of the plurality of light-emitting units, to emit light and dim or turn off a light-emitting unit that is a light source of light emitted from the display surface to a direction different from the viewer position.

The light beam control unit may control, in a control direction that is a direction parallel to the display surface, a direction in which light that has entered from each of the light-emitting units travels, and the light emission control unit may control each of the light-emitting units in accordance with a position of each of the light-emitting units in the control direction relative to the light beam control unit.

The light beam control unit may be a lens that has a curvature in the control direction.

The control direction may be all directions parallel to the display surface, and the light beam control unit may be a lens array that includes a lens having a curvature in the all directions.

The control direction may be one direction parallel to the display surface, and the light beam control unit may be a lens array that includes a lens having a curvature in the one direction.

The backlight may be a direct backlight in which the plurality of light-emitting units faces a surface of the display panel opposite to the display surface, and the light beam control unit may be disposed between the backlight and the display panel.

The backlight may include backlights that are edge backlights in which the plurality of light-emitting units is arranged along a peripheral edge of the display panel, and the light beam control unit may be disposed between the backlights.

The display device may further include a video generation unit that generates video to be displayed on the display surface,
the light emission control unit controlling each of the light-emitting units in accordance with brightness of each region of the video and controlling each of the light-emitting units on a basis of the emission direction and the viewer position.

The display device may further include a video generation unit that generates video to be displayed on the display surface,
the video generation unit correcting the video in accordance with the viewer position and a control state of each of the light-emitting units by the light emission control unit.

The light emission control unit may control, when the viewer position is equal to or less than a certain number, each of the light-emitting units on a basis of the emission direction and the viewer position, and cause, when the viewer position exceeds the certain number, all of the plurality of light-emitting units to emit light.

The display device may further include a sensor that detects a viewer facing the display surface,
the viewer position recognition unit recognizing the viewer position on a basis of a detection result of the sensor.

The sensor may track a face or an eye of the viewer facing the display surface, and
the viewer position recognition unit may recognize the viewer position on a basis of a result of the tracking.

The sensor may track a line of sight of the viewer facing the display surface, and
the viewer position recognition unit does not necessarily need to recognize, when the line of sight is not directed toward the display surface, a position of the viewer as the viewer position.

The sensor may identify the viewer facing the display surface, and
the light emission control unit does not necessarily need to recognize, when the viewer facing the display surface is not a viewer registered in advance, a position of the viewer as the viewer position.

The sensor may detect the viewer facing the display surface using a temperature, infrared rays, sound, or a radio wave.

The light emission control unit may cause, when the viewer position is not recognized by the viewer position recognition unit, a light-emitting unit that is a light source of light emitted from the display surface toward an outermost side, of the plurality of light-emitting units, to emit light and dim or turn off a light-emitting unit that is a light source of light emitted from the display surface to a direction that is not the outermost side.

The light emission control unit may cause, when the viewer position is not recognized by the viewer position recognition unit, a light-emitting unit that is a light source of light emitted from the display surface toward the viewer position and a light-emitting unit that is a light source of light emitted from the display surface toward the outermost side to emit light and dim or turn off a light-emitting unit that is a light source of light emitted from the display surface to a direction that is different from the viewer position and is not the outermost side.

In order to achieve the above-mentioned object, a program according to an embodiment of the present technology causes a display device to operate as: a viewer position recognition unit; and a light emission control unit.

The viewer position recognition unit recognizes a viewer position that is a position of a viewer relative to a display surface of a display panel.

The light emission control unit controls each of a plurality of light-emitting units included in a backlight on a basis of a direction in which light from each of the light-emitting units as a light source is emitted from the display surface and the viewer position, each of the light-emitting units emitting light that enters a light beam control unit from each of the light-emitting units, is controlled to travel in a direction corresponding to a light-emitting unit that is a light source and be emitted, and is transmitted through the display panel and emitted from the display surface.

In order to achieve the above-mentioned object, a control method for a display device according to an embodiment of the present technology includes:
recognizing a viewer position that is a position of a viewer relative to a display surface of a display panel; and
controlling each of a plurality of light-emitting units included in a backlight on a basis of a direction in which light from each of the light-emitting units as a light source is emitted from the display surface and the viewer position, each of the light-emitting units emitting light that enters a light beam control unit from each of the light-emitting units, is controlled to travel in a direction corresponding to a light-emitting unit that is a light source and be emitted, and is transmitted through the display panel and emitted from the display surface.

### BRIEF DESCRIPTION OF DRAWINGS

FIG. 1 is a schematic diagram of a display device according to an embodiment of the present technology.

FIG. 2 is an exploded perspective view of a display unit included in the display device.

FIG. 3 is a cross-sectional view of the display unit.

FIG. 4 is a plan view of a backlight included in the display unit.

FIG. 5 is a plan view of a light beam control unit included in the display unit.

FIG. 6 is a schematic diagram showing a direction in which light that enters a lens included in the light beam control unit from a light-emitting unit included in the backlight and is emitted from the lens travels.

FIG. 7 is a schematic diagram showing a direction in which light travels when one of the light-emitting units facing the lens is caused to emit light.

FIG. 8 is a schematic diagram showing a direction in which light travels when one of the light-emitting units facing the lens is caused to emit light.

FIG. 9 is a schematic diagram showing light that enters a display panel included in the display unit.

FIG. 10 is a schematic diagram showing detection of a viewer by a sensor included in the display device.

FIG. 11 is a block diagram showing a configuration of a control unit included in the display device.

FIG. 12 is a schematic diagram showing control (X direction) of the light-emitting unit by a light emission control unit included in the control unit.

FIG. 13 is a schematic diagram showing control (Y direction) of the light-emitting unit by the light emission control unit included in the control unit.

FIG. 14 is a schematic diagram showing control in the case where there are two viewers by the light emission control unit included in the control unit.

FIG. 15 is a schematic diagram showing control in the case where there are many viewers by the light emission control unit included in the control unit.

FIG. 16 is a schematic diagram showing an operation of the display device.

FIG. 17 is a schematic diagram showing an operation of the display device.

FIG. 18 is a schematic diagram showing an operation of the display device.

FIG. 19 is a schematic diagram showing an operation of the display device.

FIG. 20 is a schematic diagram showing a specific method of controlling the light-emitting unit in the display device.

FIG. 21 is a schematic diagram showing control by the light emission control unit included in the control unit to emit light from a display surface toward the outermost side.

FIG. 22 is a schematic diagram showing control by the light emission control unit included in the control unit to emit light from the display surface toward the outermost side and a viewer.

FIG. 23 is a block diagram showing a configuration of a control unit used in combination with local dimming by the light emission control unit included in the control unit, which is included in the display device.

FIG. 24 is a schematic diagram of local dimming.

FIG. 25 is a schematic diagram of local dimming.

FIG. 26 is a schematic diagram showing control by the light emission control unit included in the control unit in combination with local dimming.

FIG. 27 is a block diagram showing a configuration of a control unit that performs uniformity correction by the light emission control unit included in the control unit, which is included in the display device.

FIG. 28 is a plan view of a light beam control unit (X-direction lenticular lens) included in the display unit.

FIG. 29 is a cross-sectional view of the light beam control unit included in the display unit.

FIG. 30 is a schematic diagram showing an operation of the display device including the light beam control unit.

FIG. 31 is a schematic diagram showing a specific method of controlling the light-emitting unit in the display device.

FIG. 32 is a plan view of a light beam control unit (Y-direction lenticular lens) included in the display unit.

FIG. 33 is a cross-sectional view of the light beam control unit included in the display unit.

FIG. 34 is a schematic diagram showing an operation of the display device including the light beam control unit.

FIG. 35 is a schematic diagram showing a specific method of controlling the light-emitting unit in the display device.

FIG. 36 is a plan view of a light beam control unit (diagonal lenticular lens) included in the display unit.

FIG. 37 is a schematic diagram showing a specific method of controlling the light-emitting unit in the display device.

FIG. 38 is an exploded perspective view of a display unit including an edge backlight, which is included in the display device.

FIG. 39 is a plan view of a backlight and a light beam control unit included in the display unit.

FIG. 40 is a cross-sectional view of the backlight and the light beam control unit included in the display unit.

FIG. 41 is a schematic diagram showing a direction in which light emitted from the light-emitting unit in the display unit travels.

FIG. 42 is a schematic diagram showing a direction in which light emitted from the light-emitting unit in the display unit travels.

FIG. 43 is a schematic diagram showing an operation of the display device including the display unit.

FIG. 44 is a schematic diagram showing an operation of the display device including the display unit.

FIG. 45 is a schematic diagram showing an operation of the display device including the display unit.

FIG. 46 is a schematic diagram showing an operation of the display device including the display unit.

FIG. 47 is a plan view of a backlight having another configuration, which is included in the display unit.

FIG. 48 is a plan view of a backlight having another configuration, which is included in the display unit.

FIG. 49 is a block diagram showing a hardware configuration of a control unit included in the display device.

### MODE(S) FOR CARRYING OUT THE INVENTION

A display device according to an embodiment of the present technology will be described.

### [Configuration of Display Device]

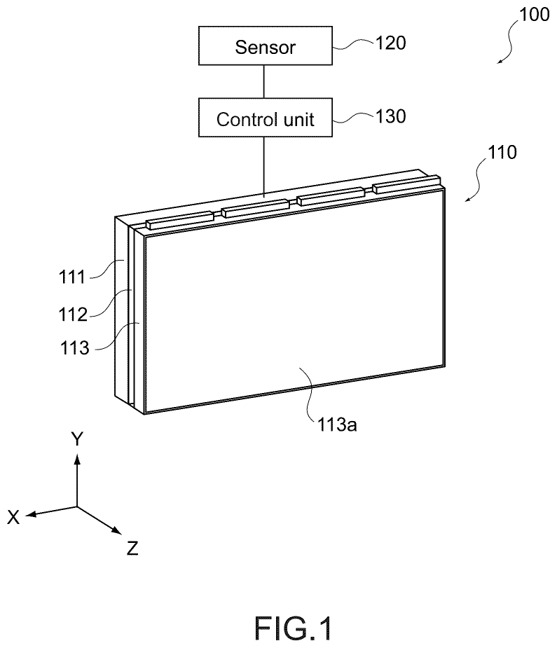

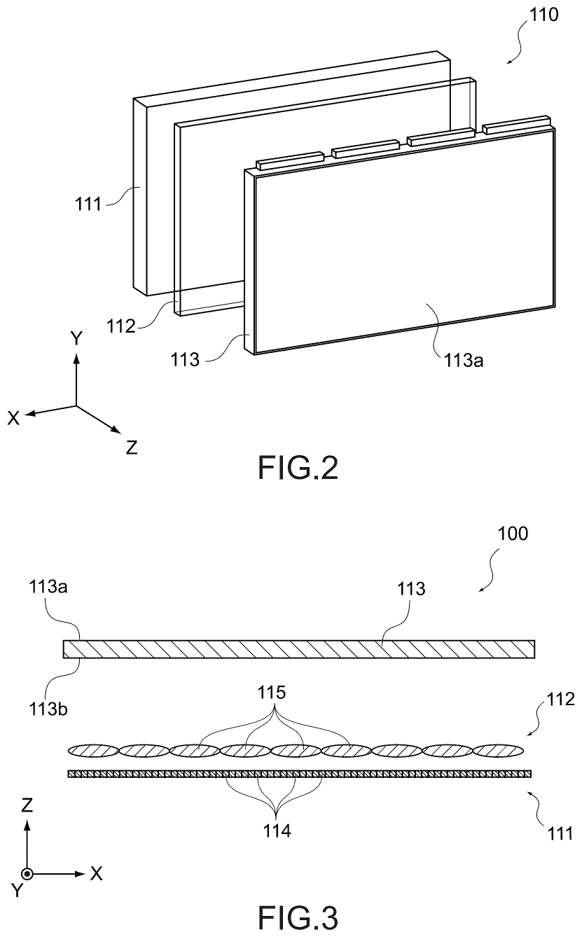

FIG. 1 is a schematic diagram of a display device 100 according to this embodiment. As shown in the figure, the display device 100 includes a display unit 110, a sensor 120, and a control unit 130. FIG. 2 is an exploded perspective view of the display unit 110, and FIG. 3 is a cross-sectional view of the display unit 110.

As shown in these figures, the display unit 110 includes a backlight 111, a light beam control unit 112, and a display panel 113. Hereinafter, a surface of the display panel 113 will be referred to as a display surface 113a, one direction parallel to the display surface 113a will be referred to as an X direction, and a direction that is parallel to the display surface 113a and perpendicular to the X direction will be referred to as a Y direction. Further, a direction perpendicular to the X direction and the Y direction will be referred to as a Z direction. The X direction is, for example, a horizontal direction, and the Y direction is, for example, a vertical direction. As shown in FIG. 3, the surface of the display panel 113 opposite to the display surface 113a will be referred to as a light-incident surface 113b.

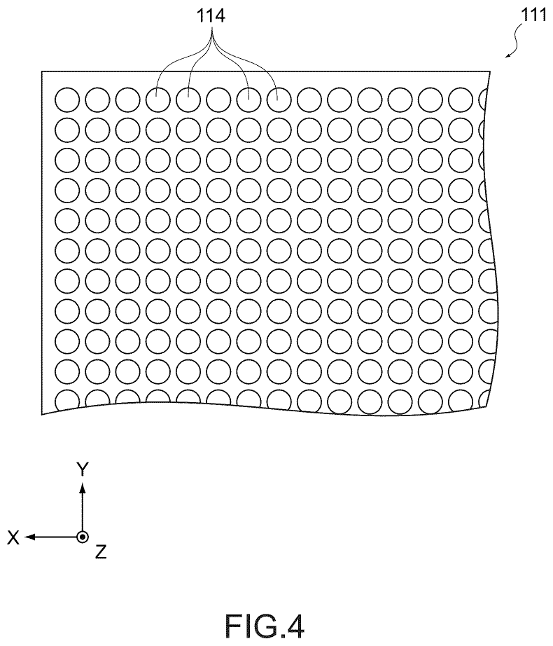

The backlight 111 is a light source of the display panel 113. FIG. 4 is a schematic diagram showing part of the backlight 111 in the enlarged illustration. As shown in the figure, the backlight 111 includes a plurality of light-emitting units 114. The light-emitting units 114 are arranged along the X direction and the Y direction. The light-emitting unit 114 is, for example, an LED (light-emitting diode) device. The backlight 111 is a direct backlight, and the light-emitting unit 114 is disposed to face the light-incident surface 113b via the light beam control unit 112.

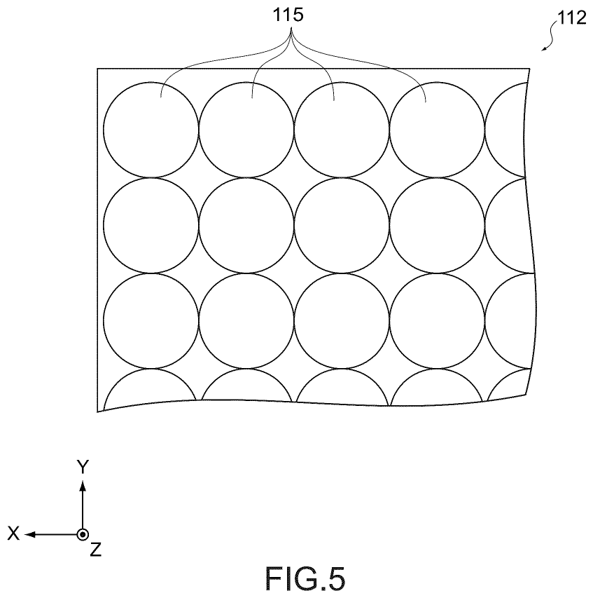

The light beam control unit 112 is disposed between the backlight 111 and the display panel 113, controls light that has entered from each of the light-emitting units 114 to travel in a direction corresponding to the position of the light-emitting unit 114 that is a light source, and emits the light. FIG. 5 is a plan view of the light beam control unit 112 when viewed from the side of the display panel 113. As shown in FIG. 3 and FIG. 5, the light beam control unit 112 is a microlens array in which a plurality of lenses 115 is arranged. The lens 115 is a convex lens that protrudes toward the side of the display panel 113 and has a curvature in all directions (including the X direction and the Y direction) parallel to the display surface 113a. As shown in FIG. 3, the light-emitting unit 114 and the lens 115 are disposed such that the plurality of light-emitting units 114 is disposed to face one lens 115. Note that the number of light-emitting units 114 facing one lens 115 is not limited and is several to several tens.

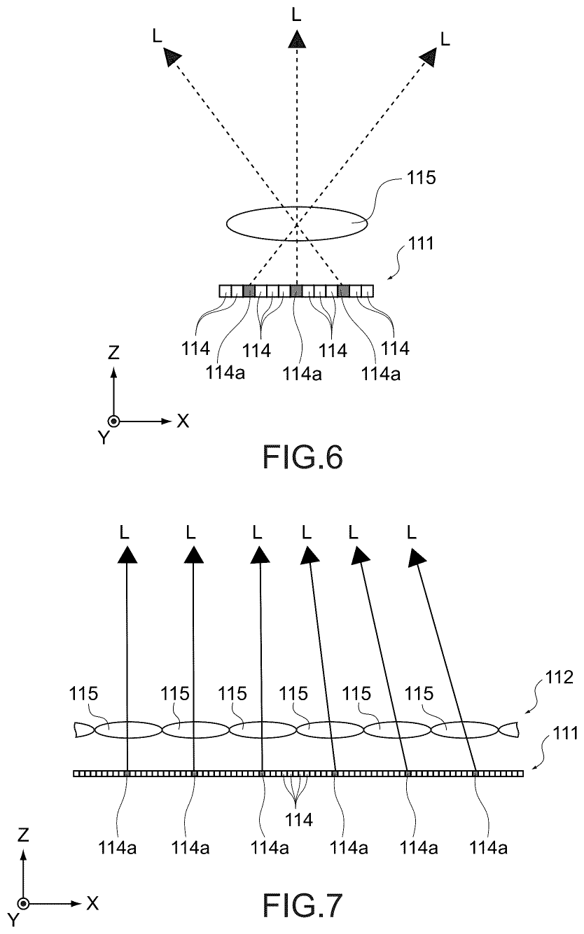

FIG. 6 is a schematic diagram showing a direction in which light that enters the lens 115 from each of the light-emitting units 114 and is emitted from the lens 115 travels, for one lens 115. Among the light-emitting units 114, those emitting light are represented as light-emitting units 114a and shown in gray. As shown in the figure, a light beam L emitted from each of the light-emitting units 114 passes through the lens 115 to travel toward a predetermined direction. The direction in which the light beam L travels is determined in accordance with a positional relationship between the light-emitting unit 114 that is a light source and the lens 115. Although the direction in which the light beam L corresponding to the position of the light-emitting unit 114 in the X direction travels is shown in FIG. 6, the light beam L with each of the light-emitting units 114 as a light source travels in a direction corresponding to the position of the light-emitting unit 114 by the lens 115 also in the Y direction similarly. In this way, the light beam control unit 112 controls light that has entered from each of the light-emitting units 114 to travel in a direction corresponding to the position of the light-emitting unit 114 that is a light source and emits the light.

Hereinafter, the direction in which the light beam control unit 112 controls the direction in which light that has entered from each of the light-emitting units 114 travels will be referred to as a “control direction”. In the light beam control unit 112 shown here, the lens 115 has a curvature in all directions (including the X direction and the Y direction) parallel to the display surface 113a, and thus, the light is refracted in all directions parallel to the display surface 113a, i.e., all directions parallel to the display surface 113a are used as the control direction. As described below, the light beam control unit 112 may include a lenticular lens. In this case, the control direction is one direction parallel to the display surface 113a.

FIG. 7 is a schematic diagram showing a direction in which the light beam L travels in the case where one light-emitting unit 114a of the light-emitting units 114 facing each lens 115 is caused to emit light. As shown in the figure, when only one light-emitting unit 114a of the light-emitting units 114 facing each lens 115 is caused to emit light, the light beam L that travels in a predetermined direction from each lens 115 is emitted in accordance with the position of the light-emitting unit 114a.

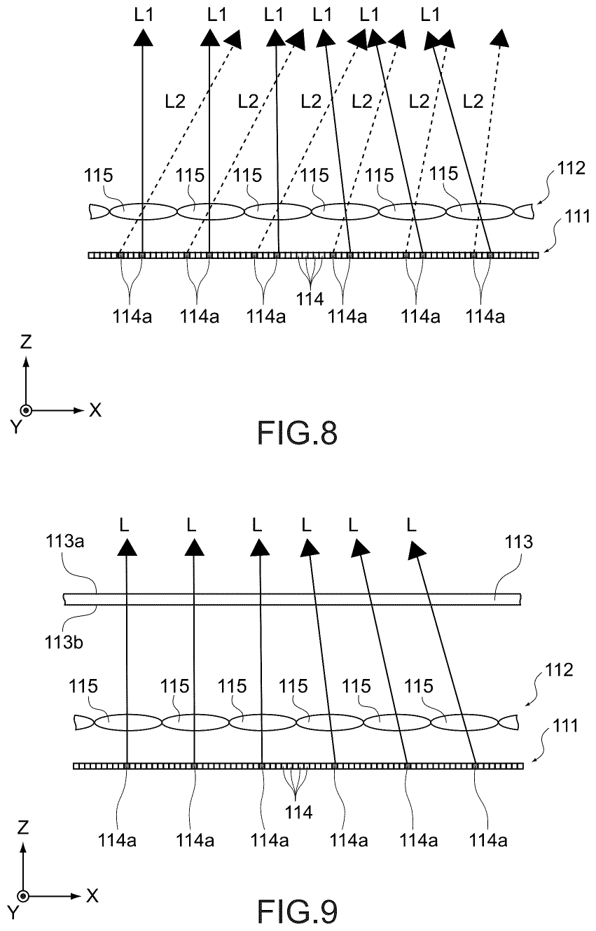

FIG. 8 is a schematic diagram showing the direction in which the light beam L travels in the case where two light-emitting units 114a of the light-emitting units 114 facing each lens 115 are caused to emit light. As shown in the figure, by selecting the light-emitting unit 114 to be caused to emit light, a light beam L1 travelling in a predetermined direction and a light beam L2 travelling in a direction different from the light beam L1 can be emitted from the light beam control unit 112. Further, by selecting the light-emitting unit 114 to be caused to emit light, light beams L travelling in three or more directions can be emitted from the light beam control unit 112. Note that although the direction in which the light beam L travels in the X direction is shown in FIG. 7 and FIG. 8, the direction in which the light beam L travels can be controlled by selecting the light-emitting unit 114 to be caused to emit light also in the Y direction similarly. Further, the direction in which the light beam L travels can be controlled by selecting the light-emitting unit 114 to be caused to emit light also in directions parallel to the display surface 113a other than the X direction and the Y direction similarly.

The display panel 113 generates video to be displayed. FIG. 9 is a schematic diagram showing light that enters the display panel 113. As shown in the figure, the light beam L emitted from the light beam control unit 112 enters the light-incident surface 113b of the display panel 113. The light beam L is transmitted through the display panel 113 and is emitted from the display surface 113a. The display panel 113 is a display panel having a general structure and is, for example, a liquid crystal display panel. The light beam L that is transmitted through the display panel 113 passes through the pixel of the display panel 113 to become the color and luminance corresponding to the state of the pixel and form video to be displayed on the display surface 113a.

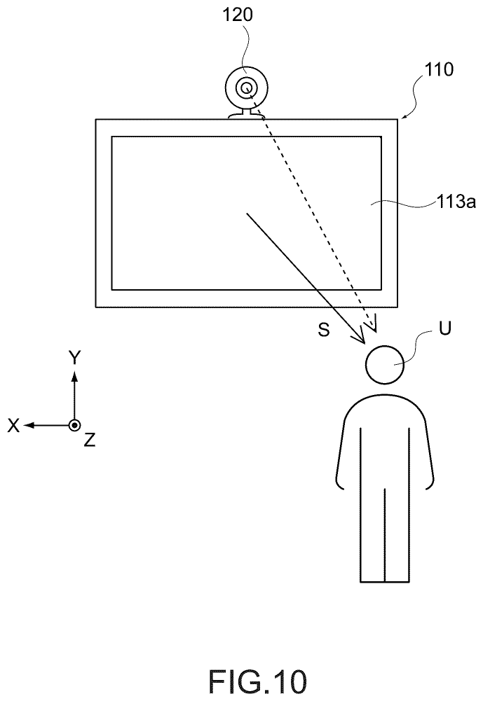

The sensor 120 detects a viewer facing the display surface 113a. FIG. 10 is a schematic diagram showing detection of a viewer by the sensor 120. In the case where a viewer U is present in the detection range, the sensor 120 detects the viewer U as shown by a dashed arrow in the figure. In the case where a plurality of viewers U is present in the detection range, the sensor 120 detects each of the viewers U. As shown in FIG. 10, the sensor 120 may be provided integrally with the display unit 110 and may be provided separately from the display unit 110.

The detection principle of the sensor 120 is not particularly limited and only needs to be capable of detecting the viewer U facing the display surface 113a. Specifically, the sensor 120 may be one having an imaging function and an image processing function and tracking the face or eye of a viewer by image processing on the captured image to detect the viewer U. Further, the sensor 120 may be one detecting the viewer U using at least one of a temperature, infrared rays, sound, or a radio wave. For example, the sensor 120 may be one detecting the viewer U using infrared rays, a radio wave, or the like of a remote controller.

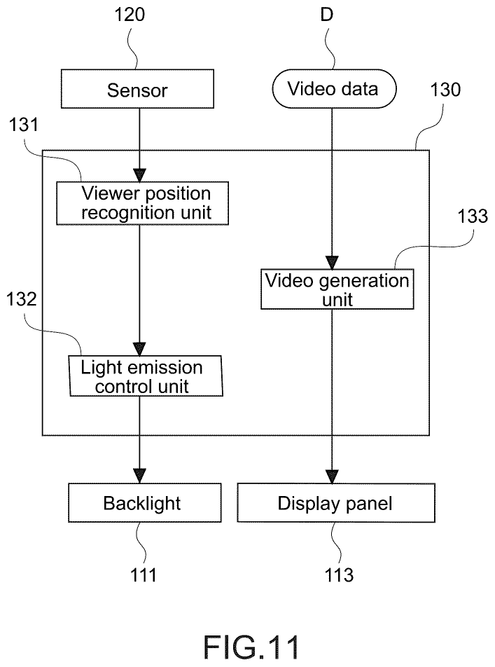

The control unit 130 controls the display unit 110. FIG. 11 is a block diagram showing a configuration of the control unit 130. As shown in the figure, the control unit 130 includes a viewer position recognition unit 131, a light emission control unit 132, and a video generation unit 133. Note that each configuration of the control unit 130 is a functional configuration that is realized by cooperation between software and hardware.

The viewer position recognition unit 131 recognizes a “viewer position” that is a position of the viewer U relative to the display surface 113a. In FIG. 10, a viewer position S recognized by the viewer position recognition unit 131 is shown. The viewer position recognition unit 131 acquires the detection result of the viewer U by the sensor 120 and is capable of recognizing the viewer position S on the basis of the disposition of the sensor 120 relative to the display surface 113a and the detection result of the sensor 120. In the case where a plurality of viewers U is present facing the display surface 113a, the viewer position recognition unit 131 recognizes the position of each viewer U relative to the display surface 113a as the viewer position S. When the viewer U moves or the number of viewers U increases or decreases, the viewer position recognition unit 131 recognizes the position of a new viewer U as the viewer position S. The viewer position recognition unit 131 supplies the recognized viewer position S to the light emission control unit 132.

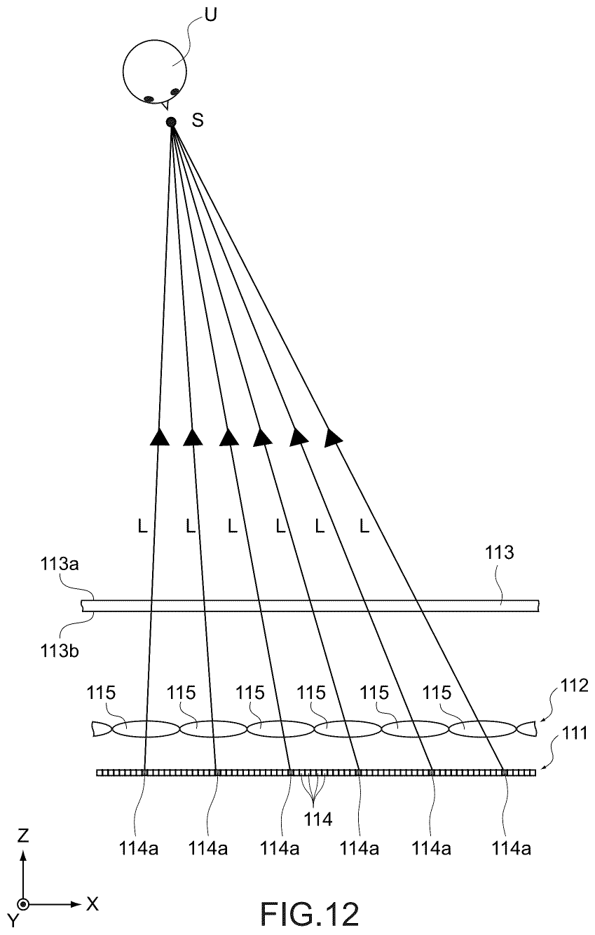

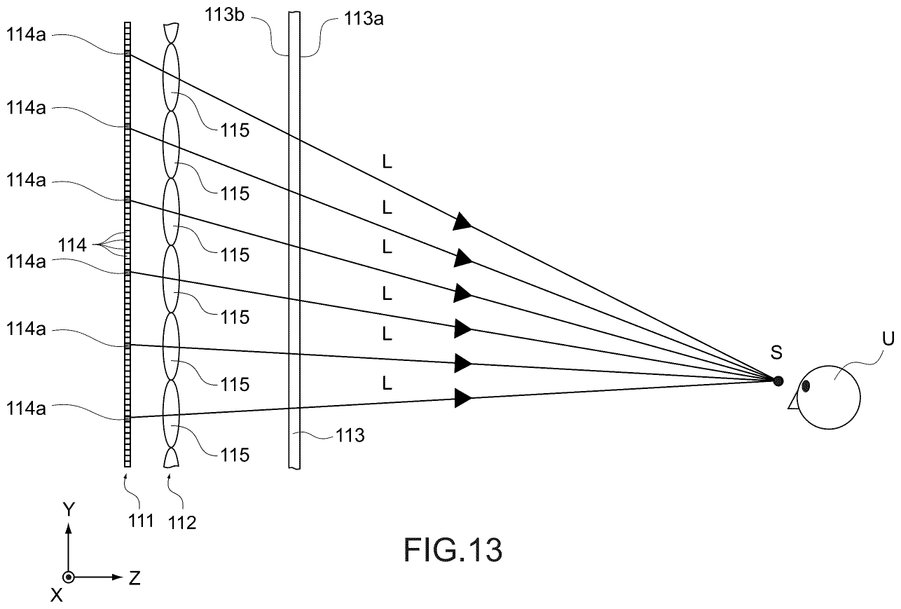

The light emission control unit 132 controls the light-emitting unit 114 on the basis of the direction in which the light beam L from each of the light-emitting units 114 as a light source is emitted from the display surface 113a and the viewer position S. Specifically, the light emission control unit 132 controls each of the light-emitting units 114 in accordance with the position of each of the light-emitting units 114 in the control direction (all directions parallel to the display surface 113a) relative to the light beam control unit 112. FIG. 12 and FIG. 13 are each a schematic diagram showing control of the light-emitting unit 114 by the light emission control unit 132. FIG. 12 shows the control of the light-emitting unit 114 in the X direction, and FIG. 13 shows the control of the light-emitting unit 114 in the Y direction.

As shown in these figures, the light emission control unit 132 causes the light-emitting unit 114a that is a light source of the light beam L emitted from the display surface 113a toward the viewer position S, of the light-emitting units 114, to emit light. Meanwhile, the light emission control unit 132 turns off the light-emitting unit 114 other than the light-emitting unit 114a. Note that although the light beam L is indicated by an arrow in each figure, the light beam L is actually diffused to some extent and emitted from the display surface 113a. Therefore, the light beam L emitted from the display surface 113a toward the viewer position S only needs to have the viewer position S in the irradiation range and is not limited to the light that is strictly applied only to the viewer position S. Note that a member having a diffusion function, such as a diffuser plate, may be provided between the lens 115 and the display surface 113a.

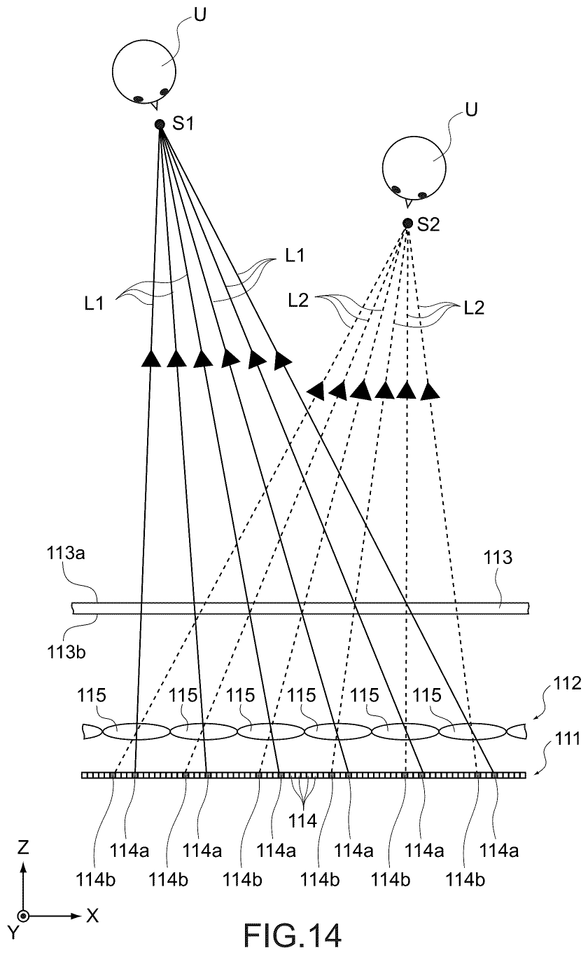

FIG. 14 is a schematic diagram in the case where there are two viewers U facing the display surface 113a. As shown in the figure, the viewer position recognition unit 131 recognizes a viewer position S1 and a viewer position S2. The light emission control unit 132 causes the light-emitting unit 114a that is a light source of the light beam L1 emitted from the display surface 113a toward the viewer position S1, of the light-emitting units 114a, and a light-emitting unit 114b that is a light source of the light beam L2 emitted from the display surface 113a toward the viewer position S2 to emit light. Further, the light emission control unit 132 turns off the light-emitting unit 114 other than the light-emitting unit 114a and the light-emitting unit 114b. The light emission control unit 132 controls the light-emitting unit 114 in accordance with the viewer position S1 and the viewer position S2 also in the Y direction as in FIG. 13.

Similarly, in the case where there are three or more viewers U facing the display surface 113a, the light emission control unit 132 causes the light-emitting unit 114 that is a light source of the light beam L emitted from the display surface 113a toward the viewer position S to emit light and turns off the other light-emitting units 114. When the viewer U moves or the number of viewers U increases or decreases, the light emission control unit 132 causes the light-emitting unit 114 that is a light source of the light beam L emitted from the display surface 113a toward a new viewer position S to emit light and turns off the other light-emitting units 114.

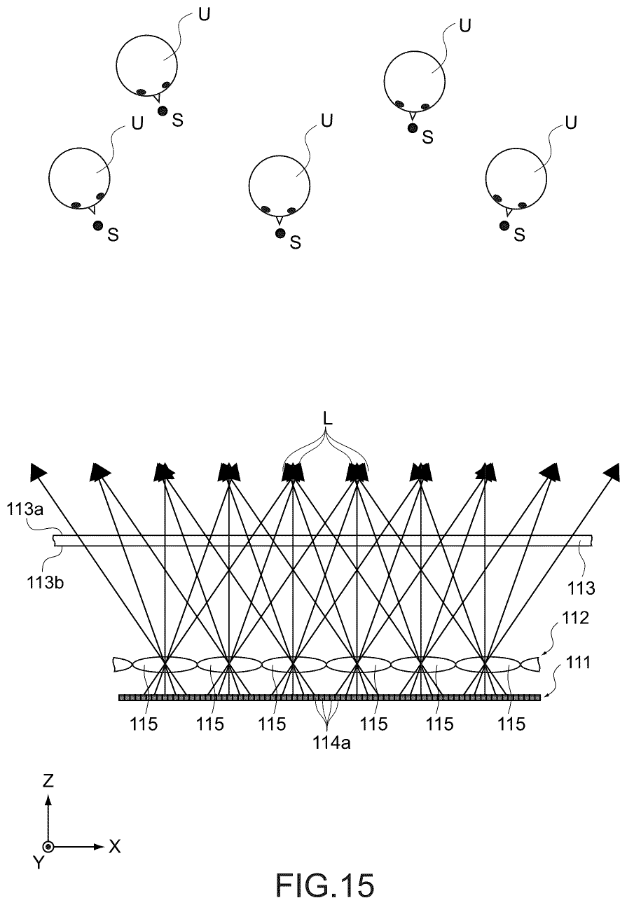

Further, in the case where there are many viewers U facing the display surface 113a, the light emission control unit 132 stops the above-mentioned control based on the viewer position S. FIG. 15 is a schematic diagram showing the control of the light-emitting unit 114 by the light emission control unit 132 in the case where there are many viewers U. In the case where the viewer position S supplied from the viewer position recognition unit 131 exceeds a certain number, the light emission control unit 132 causes all the light-emitting units 114 to emit light as shown in the figure. This certain number is not particularly limited but is, for example, three.

The video generation unit 133 generates video to be displayed on the display surface 113a and supplies the generated video to the display panel 113. As shown in FIG. 11, the video generation unit 133 acquires video data D from a device connected to the display device 100 or the network and generates video to be displayed on the display surface 113a from the video data D. The video data is data of a moving image or a still image and is not particularly limited.

### [Operation and Effect of Display Device]

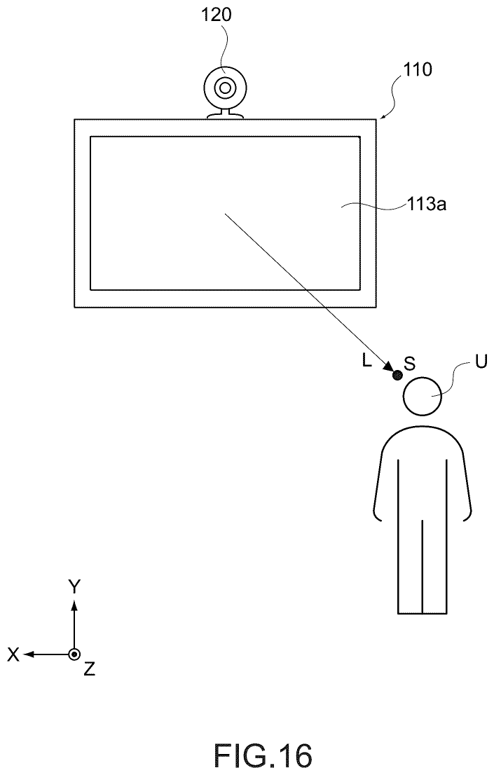

The operation and effect of the display device 100 will be described. FIG. 16 to FIG. 19 are each a schematic diagram showing the operation of the display device 100. As shown in FIG. 16, in the case where there is a viewer U facing the display surface 113a, the light emission control unit 132 causes the light-emitting unit 114 that is a light source of the light beam L emitted from the display surface 113a toward the viewer position S to emit light and turns off the other light-emitting units 114, as described above. As a result, when the display surface 113a is viewed from the viewer U, the light beam L transmitted through the display panel 113 toward the viewer position S is visible and the video displayed on the display surface 113a can be viewed in the same manner as in a general display. Meanwhile, the other light-emitting units 114 are turned off, and thus, it is possible to reduce power consumption of the display panel 113. In particular, the power consumption of the backlight 111 accounts for a large portion of the power consumption of the display unit 110, and thus, significant power saving of the display unit 110 can be achieved.

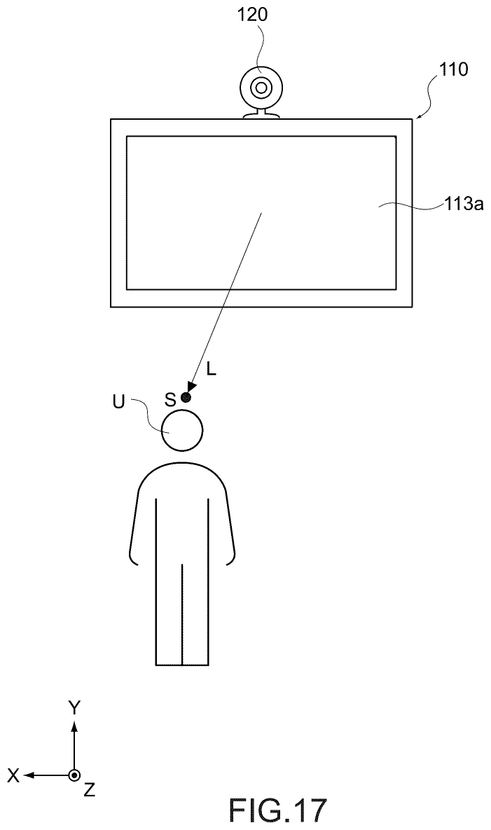

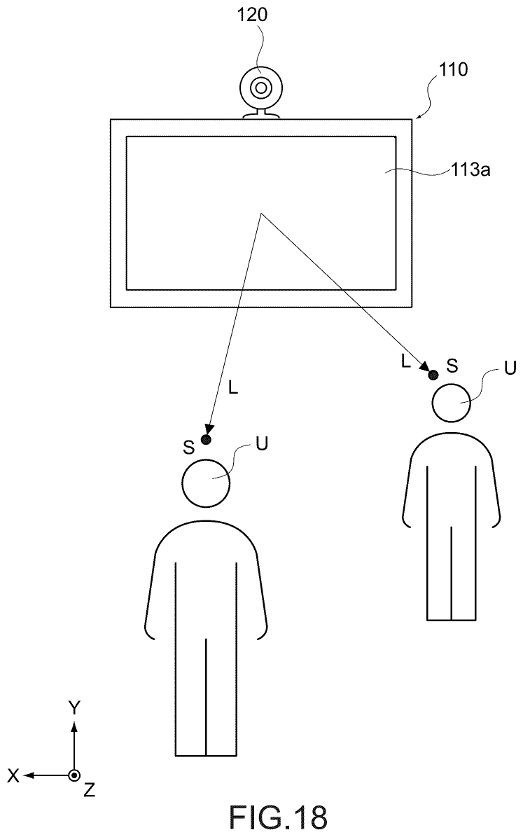

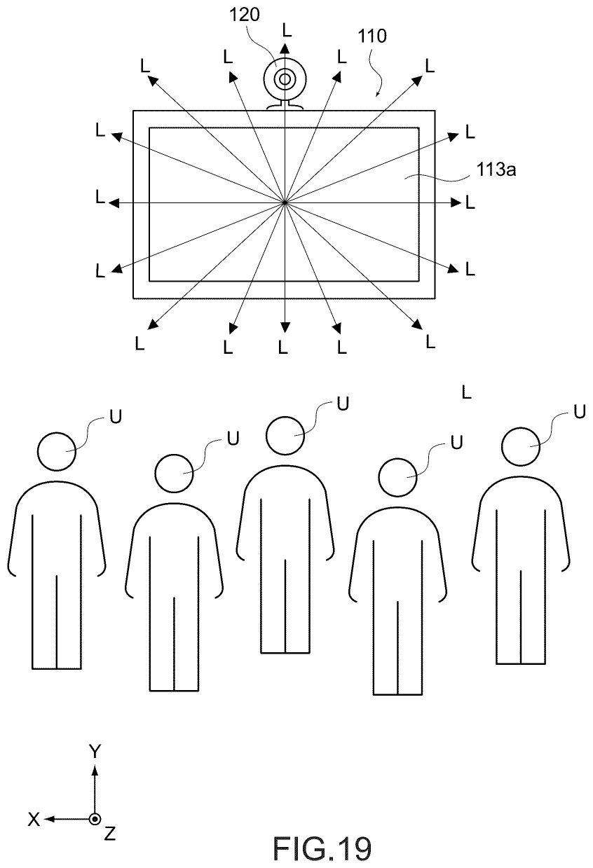

As shown in FIG. 17, also in the case where the viewer U moves, since the light-emitting unit 114 is controlled on the basis of a new viewer position S and the light beam L toward the viewer position S is emitted from the display surface 113a, the viewer U can view displayed video as in a general display. Further, as shown in FIG. 18, also in the case where there are a plurality of viewers U, since the light-emitting unit 114 is controlled on the basis of the viewer position S of each viewer U and the light beam L toward each viewer position S is emitted from the display surface 113a, a plurality of viewers U can view displayed video as in a general display. Meanwhile, as shown in FIG. 19, in the case where there are many viewers U, all the light-emitting units 114 are caused to emit light and each viewer U can view video as in a general display.

Note that although the light emission control unit 132 causes the light-emitting unit 114 that is a light source of the light beam L emitted toward the viewer position S to emit light and the other light-emitting units 114 are turned off in the above description, the other light-emitting units 114 may be dimmed without being turned off. In this case, when the display surface 113a is viewed from a position other than the viewer position S, displayed video can be viewed although it is darker than when viewed from a position other than the viewer position S. This is effective, for example, when checking, from the detection range of the sensor 120, whether or not the power source of the display panel 113 is turned on. Further, the light emission control unit 132 may cause the light-emitting unit 114 that is a light source of the light beam L emitted from the display surface 113a toward the viewer position S to emit light and dim the other light-emitting units 114 as away from the light-emitting unit 114.

### [Specific Method of Controlling Light-Emitting Unit]

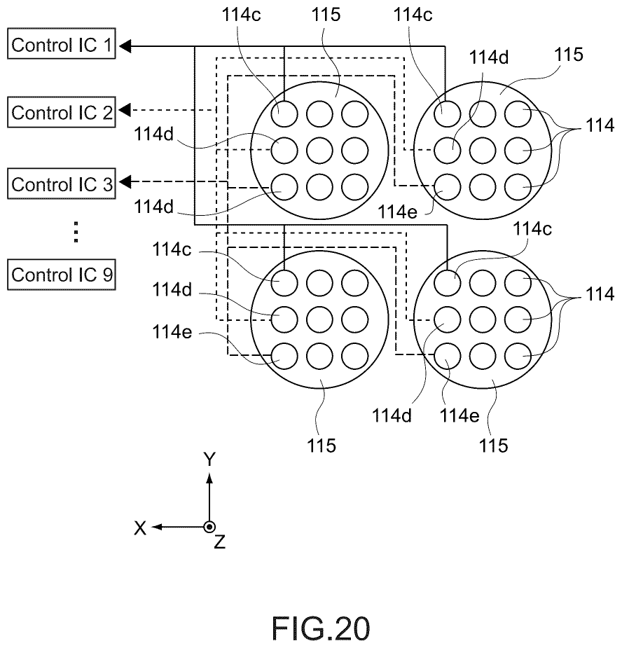

The specific method of controlling the light-emitting unit 114 will be described. FIG. 20 is a schematic diagram showing a specific method of controlling the light-emitting unit 114. As shown in the figure, a structure in which nine light-emitting units 114 faces one lens 115 will be described as an example. The same number of control ICs (Integrated Circuits) as the number of light-emitting units 114 facing each lens 115 are provided on the display unit 110, and nine control ICs are provided in this case. Of the light-emitting units 114 facing each lens 115, the one located at the top left is a light-emitting unit 114c, the one located below the light-emitting unit 114c is a light-emitting unit 114d, and the one located below the light-emitting unit 114d is a light-emitting unit 114e. Each light-emitting unit 114c is connected to a control IC1, each light-emitting unit 114d is connected to a control IC2, and each light-emitting unit 114e is connected to a control IC3. Similarly, each of the light-emitting units 114 is connected to the control IC for each position relative to the lens 115.

In this configuration, when the light emission control unit 132 selects the control IC to be driven, the control IC supplies a drive signal to the light-emitting unit 114 connected to the control IC, and the light-emitting unit 114 to which the drive signal has been supplied, of the light-emitting units 114 facing each lens 115, emits light. For this reason, the light emission control unit 132 selects, on the basis of the viewer position S, the control IC to be driven and causes the light-emitting unit 114 that is a light source of the light beam L emitted from the display surface 113a toward the viewer position S to emit light. Therefore, the light emission control unit 132 controls each of the light-emitting units 114 in accordance with the position relative to the light beam control unit 112 in the control direction (e.g., the X direction and the Y direction). In this way, the light emission control unit 132 is capable of controlling the light-emitting unit 114. Note that the method of controlling the light-emitting unit 114 is not limited to the one shown here and only needs to be capable of controlling each of the light-emitting units 114 in accordance with the position relative to the light beam control unit 112 in the control direction.

### [Other Configurations of Viewer Position Recognition Unit]

The viewer position recognition unit 131 is also capable of using a result of tracking the line of sight of the viewer U when recognizing the viewer position S as described above. Specifically, the sensor 120 tracks the line of sight of the viewer U and supplies the tracking result to the viewer position recognition unit 131. For the line-of-sight tracking, a general line-of-sight tracking technology can be used. When the line of sight of the viewer U is directed toward the display surface 113a, the viewer position recognition unit 131 recognizes the position of the viewer U as the viewer position S as described above. Meanwhile, when the line of sight of the viewer U is not directed toward the display surface 113a, the viewer position recognition unit 131 does not recognize the position of the viewer U as the viewer position S. As a result, when the line of sight of the viewer U moves away from the display surface 113a, the light emission control unit 132 turns off or dims the light-emitting unit 114 that is a light source of the light beam L emitted toward the viewer position S of the viewer U. This makes it possible to further reduce the power consumption of the display unit 110.

Further, the viewer position recognition unit 131 is also capable of using a result of identifying the viewer U when recognizing the viewer position S as described above. Specifically, the sensor 120 identifies the viewer U by image processing or the like on a captured image and supplies the identification result to the viewer position recognition unit 131. For the identification of the viewer U, a general identification technology such as face recognition can be used. When the viewer U is a person registered in advance, the viewer position recognition unit 131 recognizes the position of the viewer U as the viewer position S as described above. Meanwhile, when the viewer U is a person who is not registered in advance, the viewer position recognition unit 131 does not recognize the position of the viewer U as the viewer position S. As a result, in the case where the viewer U is not registered, the light emission control unit 132 dims or turns off the light-emitting unit 114 that is a light source of the light beam L emitted toward the viewer U. This makes it possible to further reduce the power consumption of the display unit 110.

This configuration is effective also in the case where a person who is located in the vicinity of the display unit 110 but does not desire to view displayed video is present or it is desired to prevent information from leaking to outsiders. Conversely, the viewer position recognition unit 131 may recognize, in the case where the viewer U is a person who is not registered in advance, the position of the viewer U as the viewer position S and refrain from recognizing, in the case where the viewer U is a person who is registered in advance, the position of the viewer U as the viewer position S.

### [Other Configurations of Light Emission Control Unit]

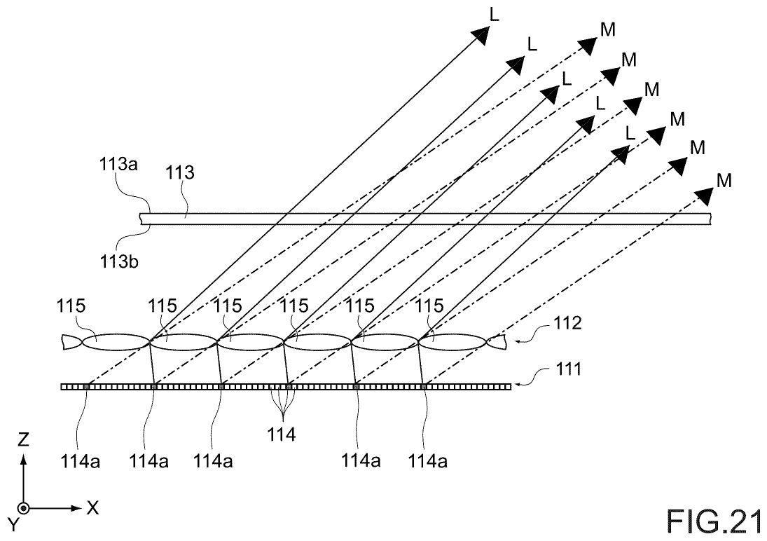

Although the light emission control unit 132 causes the light-emitting unit 114 that is a light source of the light beam L emitted from the display surface 113a toward the viewer position S to emit light as described above, the light-emitting unit 114 that is a light source of light emitted from the display surface 113a toward the outermost side may be caused to emit light in the case where no viewer facing the display surface 113a is present. FIG. 21 is a schematic diagram showing the control of the light-emitting unit 114 by the light emission control unit 132 in this case. In the case where the viewer position S is not recognized by the viewer position recognition unit 131, the light emission control unit 132 causes the light-emitting unit 114a that is a light source of light M emitted from the display surface 113a to the outermost side (widest angle), of the light-emitting units 114 facing each lens 115, to emit light, as shown in FIG. 21. Further, the light emission control unit 132 dims or turns off the light-emitting unit 114 other than the light-emitting unit 114a. The light beam L shown in the figure is a light beam as originally designed, and the light M is light that has been transmitted through the boundary of the lens 115. Since the light emitted from the display surface 113a is dominated by the light M, this light M is utilized. This allows the viewer U located outside the detection range of the sensor 120 to view the displayed video of the display surface 113a by the light M. Note that the position of the light source to be turned on may be the entire outer periphery. Further, the position of the outer periphery in the direction at the time point when the viewer U became unable to be recognized may be turned on. Further, a function of setting the direction by the viewer U may be provided. When the viewer position S is recognized, the light emission control unit 132 controls the light-emitting unit 114 on the basis of the direction in which the light beam L is emitted and the viewer position S as described above.

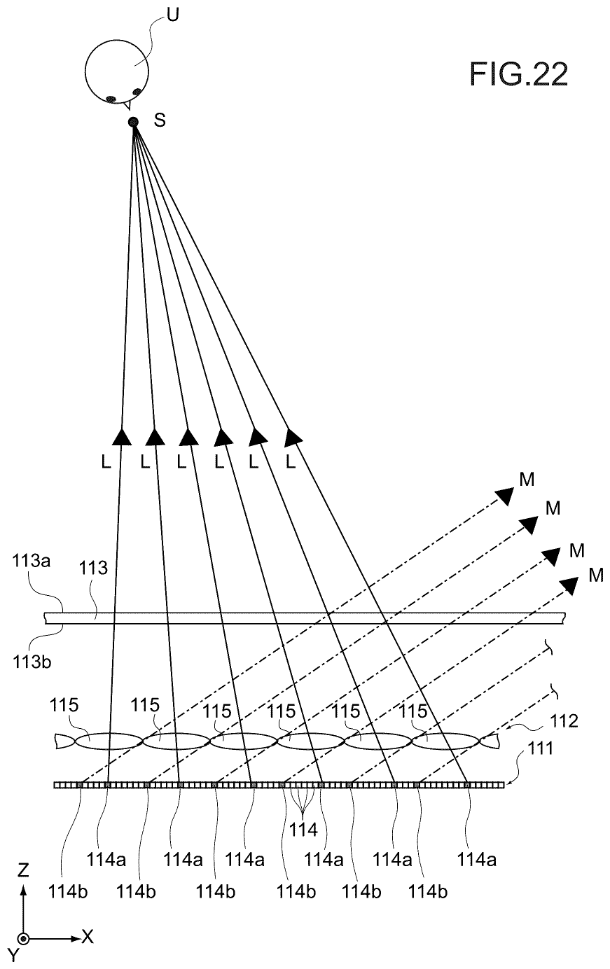

Further, also when the viewer position S is recognized, the light emission control unit 132 may cause the light-emitting unit 114 that is a light source of light emitted from the display surface 113a to the outermost side to emit light. FIG. 22 is a schematic diagram showing the control of the light-emitting unit 114 by the light emission control unit 132 in this case. As shown in FIG. 22, the light emission control unit 132 causes the light-emitting unit 114a that is a light source of the light beam L emitted from the display surface 113a toward the viewer position S to emit light and causes the light-emitting unit 114b that is a light source of the light M emitted from the display surface 113a toward the outermost side to emit light. Further, the light emission control unit 132 dims or turns off the light-emitting unit 114 other than the light-emitting unit 114a and the light-emitting unit 114b. This allows the viewer U who is located within the detection range and outside the detection range of the sensor 120 to view the displayed video of the display surface 113a.

As shown in FIG. 21 and FIG. 22, the configuration in which the light emission control unit 132 causes the light-emitting unit 114 that is a light source of light emitted toward the outermost side to emit light is effective in reducing power consumption when the display device 100 is displayed and sold at a home appliance store.

[Regarding Use in Combination with Local Dimming]

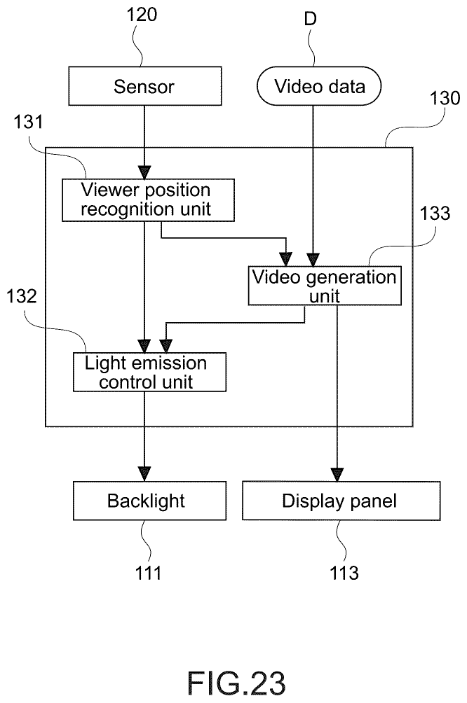

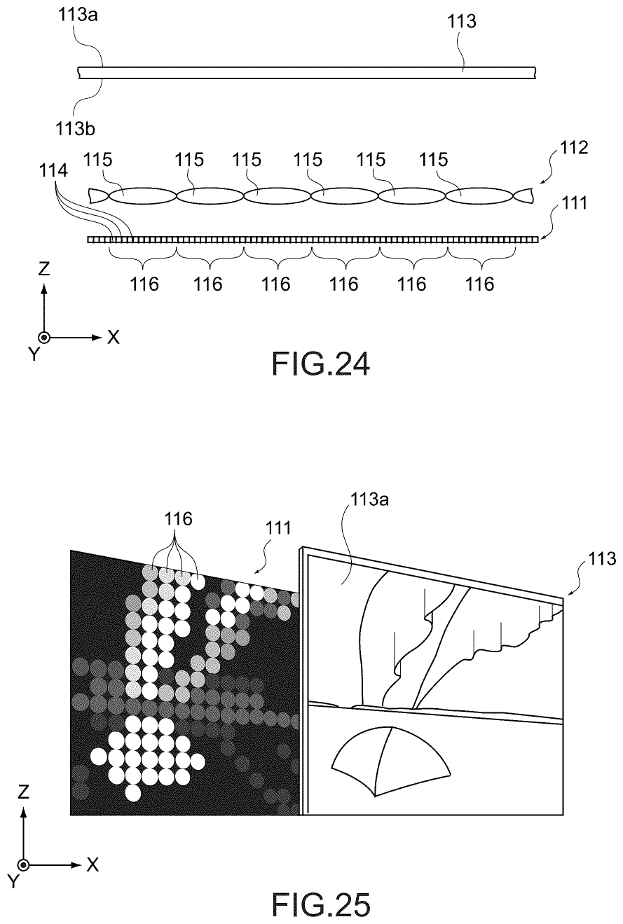

The light emission control unit 132 may also combine the above-mentioned control of the light-emitting unit 114 based on the viewer position S with local dimming. FIG. 23 is a block diagram showing a configuration of the control unit 130 used in combination of local dimming. FIG. 24 and FIG. 25 are each a schematic diagram of local dimming. As shown in FIG. 24 and FIG. 25, the backlight 111 is divided into a number of light-emitting regions 116, and each of the light-emitting regions 116 includes the plurality of light-emitting units 114. In local dimming, as shown in FIG. 25, the amount of light emitted from each light-emitting unit 114 increases and decreases for each light-emitting region 116 in accordance with the brightness of each region in the displayed video of the display surface 113a. This makes it possible to increase the contrast of displayed video and reduce power consumption. Note that although the light-emitting region 116 is provided for each lens 115 in FIG. 25, it may be provided independently of the lens 115.

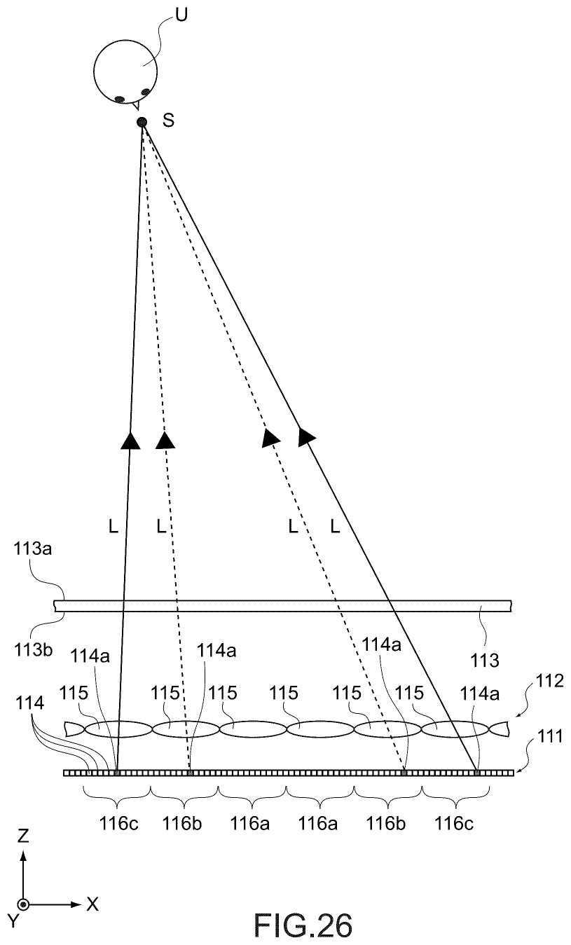

As shown in FIG. 23, in this configuration, the video generation unit 133 supplies, upon generating video to be displayed, information indicating the brightness of each region of the displayed video (hereinafter, brightness information) to the light emission control unit 132. The light emission control unit 132 executes, upon acquiring brightness information, local dimming on the basis of the brightness information. FIG. 26 is a schematic diagram showing the control of the light-emitting unit 114 used in combination with local dimming. In the figure, the light-emitting region 116 turned off by local dimming is represented as a light-emitting region 116a, the dimmed light-emitting region 116 is represented as a light-emitting region 116b, and the undimmed light-emitting region 116 is represented as a light-emitting region 116c.

The light emission control unit 132 executes the above-mentioned control based on the viewer position S on the light-emitting unit 114 included in the light-emitting region 116b and the light-emitting region 116c to cause the light-emitting unit 114a to emit light. Further, the light emission control unit 132 dims or turns off the light-emitting unit 114 included in the light-emitting region 116a and the light-emitting unit 114 other than the light-emitting unit 114a, of the light-emitting units 114 included in the light-emitting region 116b and the light-emitting region 116c. This makes it possible to reduce power consumption by local dimming and reduce power consumption by controlling the light-emitting unit 114 on the basis of the viewer position S, thereby realizing further power saving.

### [Regarding Uniformity Correction]

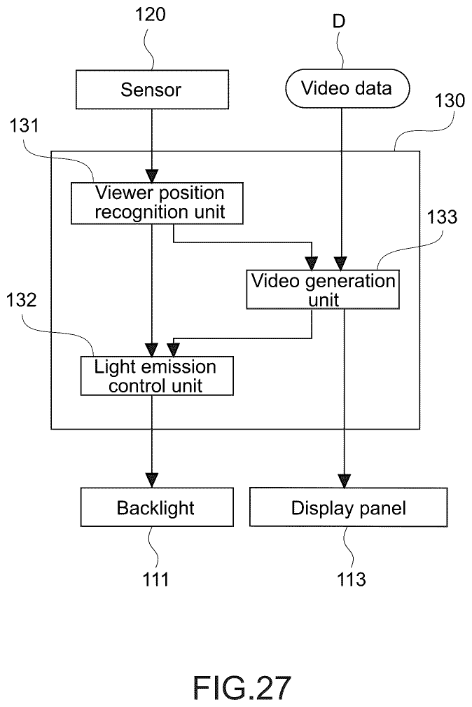

The video generation unit 133 is capable of executing uniformity correction. The uniformity correction is correction that makes the luminance and hue of the entire region of displayed video uniform. FIG. 27 is a block diagram showing a configuration of the control unit 130 for executing uniformity correction. As shown in FIG. 2, in the display unit 110, the light beam control unit 112 is disposed between the display panel 113 and the backlight 111, but this light beam control unit 112 can cause uneven luminance or color of displayed video and the uneven luminance or color differ depending on the viewing angle.

In this regard, as shown in FIG. 27, the viewer position recognition unit 131 supplies the viewer position S to the video generation unit 133. The video generation unit 133 is capable of generating video to be displayed on the basis of the viewer position S, transmitting a control signal of the light-emitting unit 114 to the light emission control unit 132, and executing uniformity correction on the displayed video. For example, uneven luminance occurs in some cases at the boundary portion of the lens 115 of the light beam control unit 112, but the video generation unit 133 is capable of eliminating such uneven luminance by brightening the region corresponding to this boundary portion, of the displayed video.

### [Other Configurations of Light Beam Control Unit]

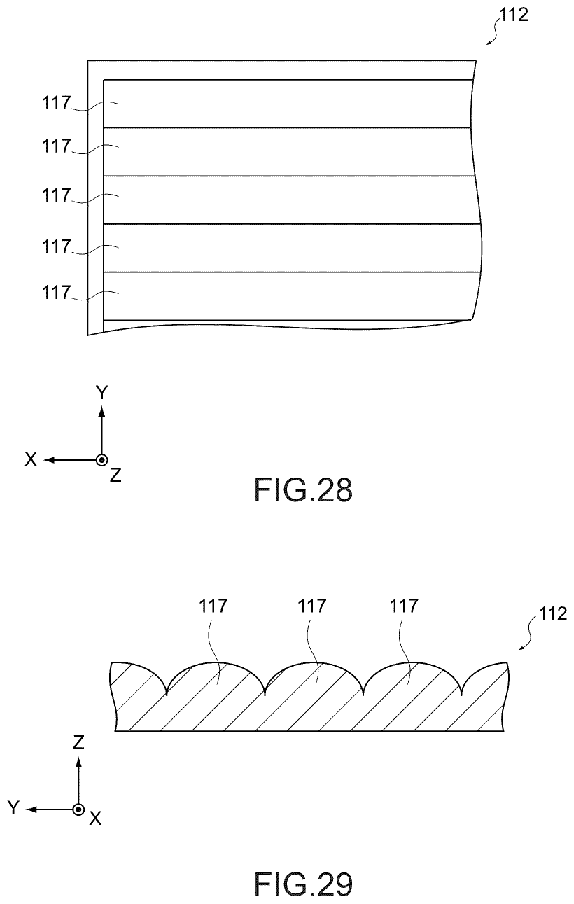

Although the light beam control unit 112 is a microlens array in which the lenses 115 are arranged and the lens 115 is a lens having a curvature in all directions (including the X direction and the Y direction) parallel to the display surface 113a, the configuration of the light beam control unit 112 is not limited thereto. FIG. 28 is a plan view of the light beam control unit 112 that is a lenticular lens in which cylindrical lenses 117 extending along the X direction are arranged, and FIG. 29 is a cross-sectional view thereof. As shown in the figure, the cylindrical lens 117 have a curvature in the Y direction and does not have a curvature in the X direction.

In this case, in the Y direction, since the light beam L from each of the light-emitting units 114 as a light source travels in a direction corresponding to the position of the light-emitting unit 114 in the Y direction, the light emission control unit 132 controls the light-emitting unit 114 in the Y direction, so that the direction in which the light beam L travels can be controlled in the Y direction as shown in FIG. 13. Meanwhile, since the cylindrical lens 117 does not operate as a lens in the X direction, the light beam L from each of the light-emitting units 114 as a light source is emitted from the display surface 113a as it is, and the direction in which the light beam L travels in the X direction as shown in FIG. 12 cannot be controlled. Therefore, the control direction of the light beam control unit 112 is the Y direction.

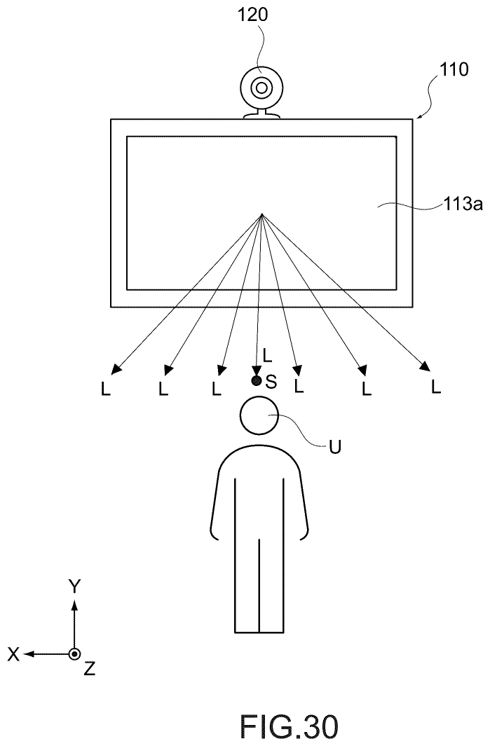

FIG. 30 is a schematic diagram showing an operation of the display device 100 in this case. The light emission control unit 132 controls the light-emitting unit 114 in accordance with the position relative to the light beam control unit 112 in the control direction (Y direction). Specifically, when the viewer position recognition unit 131 recognizes the viewer position S, the light emission control unit 132 causes the light-emitting unit 114 that is a light source of the light beam L emitted from the display surface 113a toward the viewer position S in the Y direction to emit light and dims or turns off the other light-emitting units 114. As a result, as shown in FIG. 30, the light beam L is emitted in a linear range that includes the viewer position S and is parallel to the X direction. In the case where a plurality of viewer positions S is recognized, the light emission control unit 132 causes the light-emitting unit 114 that is a light source of the light beam L emitted from the display surface 113a to each viewer position S in the Y direction to emit light and dims or turns off the other light-emitting units 114. This is effective, for example, when emitting the light beam L at the eye level of the viewer U seated on a sofa and reducing the amount of light beams L emitted at other heights.

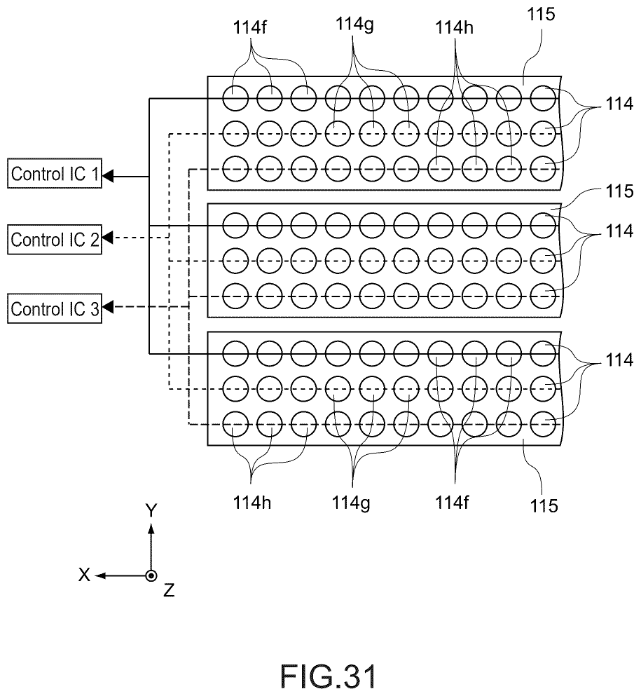

FIG. 31 is a schematic diagram showing a specific method of controlling the light-emitting unit 114 in this configuration. As shown in the figure, a structure in which three columns of light-emitting units 114 face one cylindrical lens 117 will be described as an example. The same number of control ICs as the number of columns of light-emitting units 114 facing each cylindrical lens 117 are provided on the display unit 110, and three control ICs are provided in this case. Of the columns of light-emitting units 114 facing each cylindrical lens 117, those located at the top will be referred as light-emitting units 114f, those located in the middle will be referred to as light-emitting units 114g, and those located at the bottom will be referred to as light-emitting units 114h. Each of the light-emitting units 114f is connected to the control IC1, each of the light-emitting units 114g is connected to the control IC2, and each of the light-emitting units 114h is connected to the control IC3.

In this configuration, when the light emission control unit 132 selects the control IC to be driven, the control IC supplies a drive signal to the light-emitting unit 114 connected to the control IC, and the light-emitting units 114 in the column to which the drive signal has been supplied, of the columns of the light-emitting units 114 facing each cylindrical lens 117, are caused to emit light. For this reason, the light emission control unit 132 selects the control IC to be driven on the basis of the viewer position S, causes the light-emitting unit 114 that is a light source of the light beam L emitted from the display surface 113a toward the viewer position S to emit light, and dims or turns off the other light-emitting units 114. Note that the method of controlling the light-emitting unit 114 is not limited to the one shown here and only needs to be capable of controlling each of the light-emitting units 114 in accordance with the position relative to the light beam control unit 112 in the control direction (Y direction). In this configuration, the light-emitting unit 114 can be controlled with fewer control ICs than in the configuration in which the light beam control unit 112 is a microlens array (see FIG. 20).

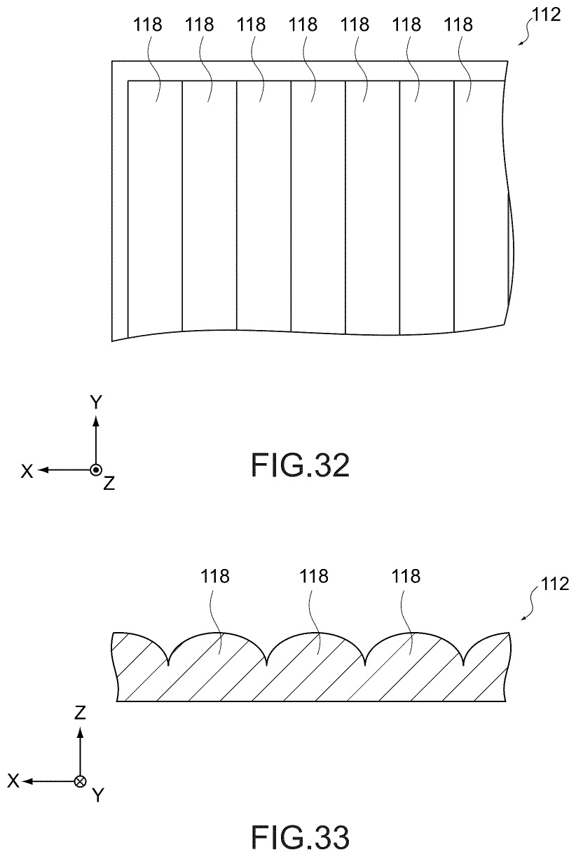

Further, FIG. 32 is a plan view of the light beam control unit 112 that is a lenticular lens in which cylindrical lenses 118 extending along the Y direction are arranged, and FIG. 33 is a cross-sectional view thereof. As shown in the figure, the cylindrical lens 118 has a curvature in the X direction and does not have a curvature in the Y direction.

In this case, in the X direction, since the light beam L from each of the light-emitting units 114 as a light source travels in a direction corresponding to the position of the light-emitting unit 114 in the X direction by the cylindrical lens 118, the light emission control unit 132 controls the light-emitting unit 114 in the X direction, making it possible to control the direction in which the light beam L travels in the X direction, as shown in FIG. 12. Meanwhile, since the cylindrical lens 118 does not operate as a lens in the Y direction, the light beam L from each of the light-emitting units 114 as a light source is emitted from the display surface 113a as it is, and the direction in which the light beam L travels in the Y direction as shown in FIG. 13 cannot be controlled. Therefore, the control direction of the light beam control unit 112 is the X direction.

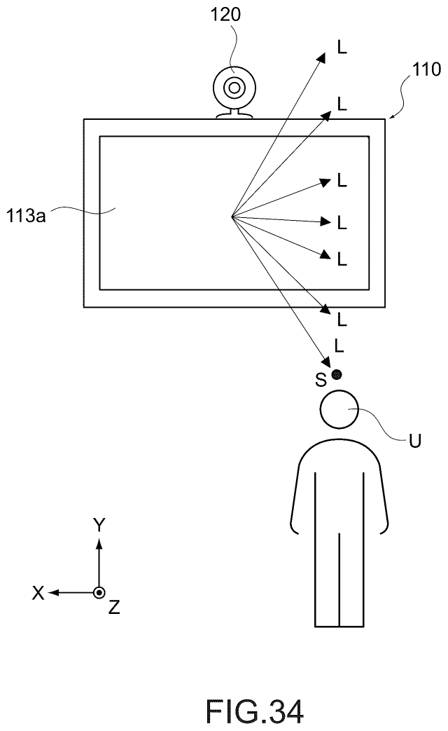

FIG. 34 is a schematic diagram showing an operation of the display device 100 in this case. The light emission control unit 132 controls the light-emitting unit 114 in accordance with the position relative to the light beam control unit 112 in the control direction (X direction). When the viewer position recognition unit 131 recognizes the viewer position S, the light emission control unit 132 causes the light-emitting unit 114 that is a light source of the light beam L emitted from the display surface 113a toward the viewer position S in the X direction to emit light and dims or turns off the other light-emitting units 114. As a result, as shown in FIG. 34, the light beam L is emitted in a linear range that includes the viewer position S and is parallel to the Y direction. In the case where a plurality of viewer positions S is recognized, the light emission control unit 132 causes the light-emitting unit 114 that is a light source of the light beam L whose emission direction in the Y direction is the direction toward each viewer position S to emit light and dims or turns off the other light-emitting units 114. This is effective, for example, when emitting the light beam L at an angle where the viewer U is present and reducing the amount of light beams L to be emitted at other angles.

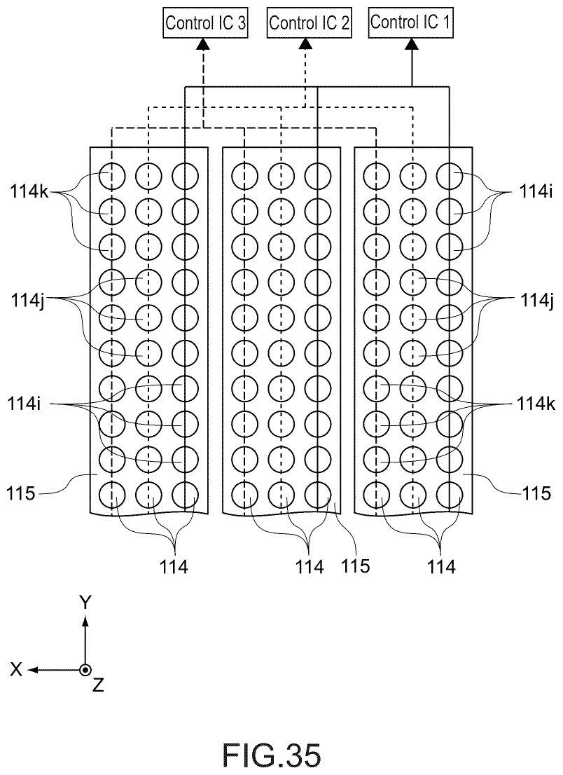

FIG. 35 is a schematic diagram showing a specific method of controlling the light-emitting unit 114 in this configuration. As shown in the figure, a structure in which three columns of light-emitting units 114 face one cylindrical lens 118 will be described as an example. The same number of control ICs as the number of columns of light-emitting units 114 facing each cylindrical lens 118 are provided on the display unit 110, and three control ICs are provided in this case. Of the columns of light-emitting units 114 facing each cylindrical lens 118, those located at the rightmost will be referred to as light-emitting units 114i, those located at the middle will be referred to as light-emitting units 114j, and those located at the leftmost will be referred to as light-emitting units 114k. Each of the light-emitting units 114i is connected to the control IC1, each of the light-emitting units 114j is connected to the control IC2, and each of the light-emitting units 114k is connected to the control IC3.

In this configuration, when the light emission control unit 132 selects the control IC to be driven, the control IC supplies a drive signal to the light-emitting unit 114 connected to the control IC, and the light-emitting units 114 in the column to which the drive signal has been supplied, of the columns of the light-emitting units 114 facing each cylindrical lens 118, are caused to emit light. For this reason, the light emission control unit 132 selects the control IC to be driven on the basis of the viewer position S, causes the light-emitting unit 114 that is a light source of the light beam L emitted from the display surface 113a toward the viewer position S to emit light, and dims or turns off the other light-emitting units 114. Note that the method of controlling the light-emitting unit 114 is not limited to the one shown here and only needs to be capable of controlling each of the light-emitting units 114 in accordance with the position relative to the light beam control unit 112 in the control direction (X direction). In this configuration, the light-emitting unit 114 can be controlled with fewer control ICs than in the configuration in which the light beam control unit 112 is a microlens array (see FIG. 20).

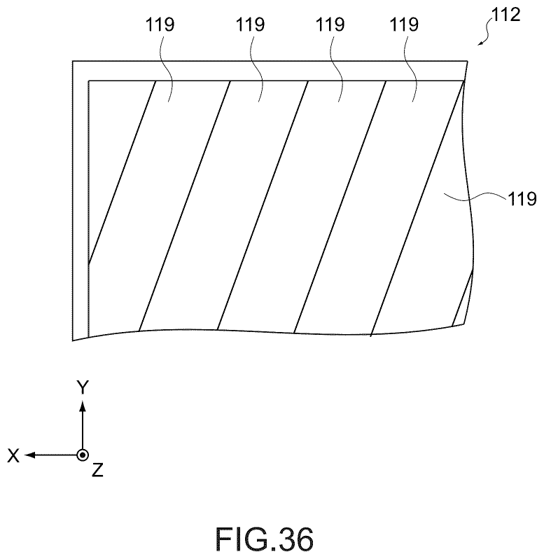

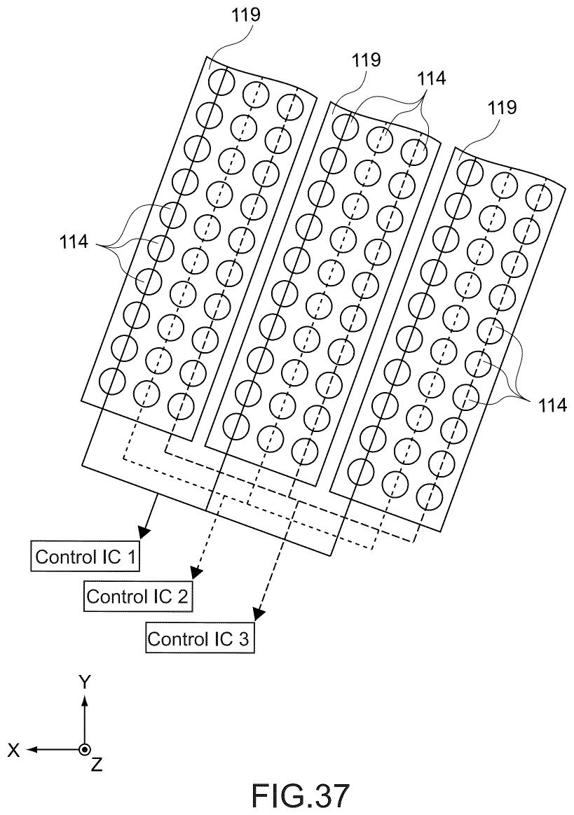

FIG. 36 is a plan view of the light beam control unit 112 that is a lenticular lens in which cylindrical lenses 119 are arranged. As shown in the figure, the cylindrical lens 119 may be one extending in a direction oblique to the X direction and the Y direction. FIG. 37 is a schematic diagram showing a specific method of controlling the light-emitting unit 114 in this configuration. As shown in the figure, the light-emitting units 114 may be arranged along the extending direction of the cylindrical lens 119 and controlled by the control IC for each column. In this configuration, it is possible to suppress moire (interference fringe) that occurs due to the positional relationship between the light-emitting unit 114 and the lenticular lens. In addition, the light beam control unit 112 only needs to be one that controls light that has entered from the light-emitting unit 114 to travel in a direction corresponding to the position of the light-emitting unit 114 that is a light source and emit the light, and may use a Fresnel lens, a DOE (Diffractive Optical Element), an HOE (Holographic Optical Element), a free-form lens, a prism, a reflective dot structure, of the like.

### [Regarding Edge Backlight]

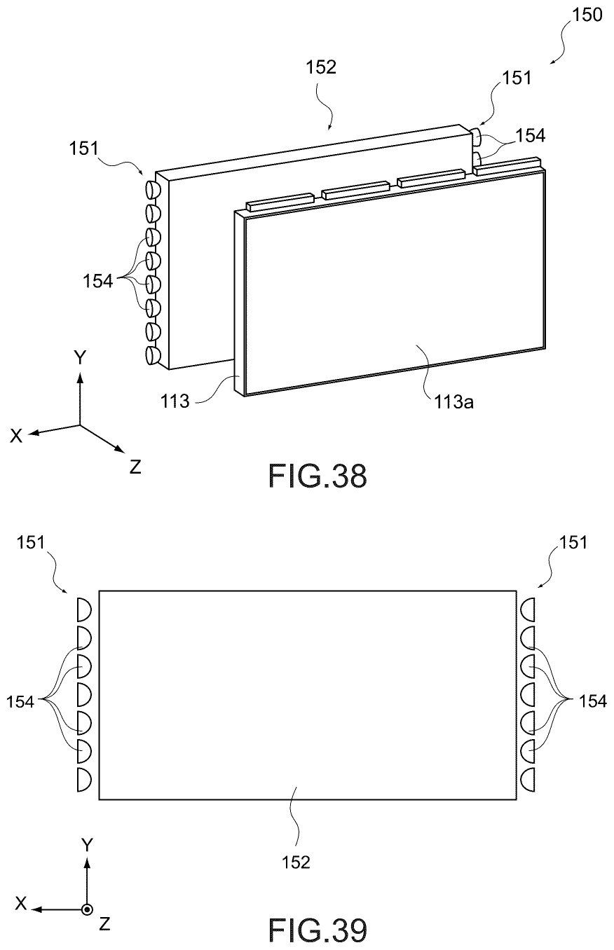

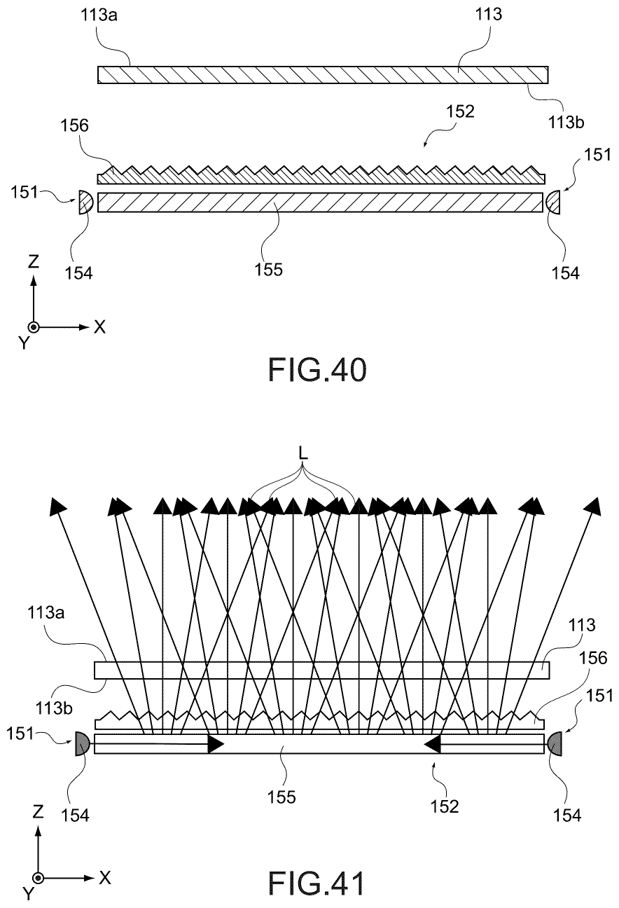

Although the display unit 110 includes the backlight 111 that is a direct backlight in the above description, it may include an edge backlight instead of the direct backlight 111. FIG. 38 is an exploded perspective view of a display unit 150 including an edge backlight. As shown in the figure, the display unit 150 includes an edge backlight 151, a light beam control unit 152, and the display panel 113. The display panel 113 has the above-mentioned configuration and has the display surface 113a and the light-incident surface 113b. FIG. 39 is a plan view of the backlight 151 and the light beam control unit 152, and FIG. 40 is a cross-sectional view thereof.

As shown in these figures, the backlight 151 includes a plurality of light-emitting units 154. The plurality of light-emitting units 154 is arranged along the peripheral edge of the display panel 113. The light-emitting unit 154 is, for example, an LED (light-emitting diode) device. The light beam control unit 152 is disposed to face the light-incident surface 113b between the plurality of light-emitting units 154.

As shown in FIG. 40, the light beam control unit 152 includes a light guide plate 155 and a reflection structure 156. The light guide plate 155 is disposed between the light-emitting units 154, and the reflection structure 156 is disposed between the light guide plate 155 and the display panel 113. The reflection structure 156 reflects the light that has entered from the light-emitting unit 154 toward the light-incident surface 113b. Specifically, the reflection structure 156 has a prism structure. Further, the reflection structure 156 may be a transmissive DOE or a reflective DOE. Note that the light guide plate 155 and the reflection structure 156 may be integrally formed.

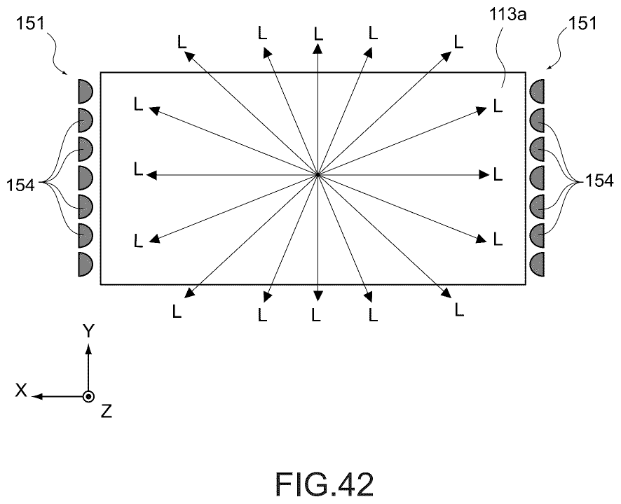

FIG. 41 and FIG. 42 are each a schematic diagram showing the light beam L emitted from each of the light-emitting units 154 in the display unit 150. As shown in these figures, when all of the light-emitting units 154 are caused to emit light, the light beam L is reflected by the reflection structure 156 toward the light-incident surface 113b and is transmitted through the display panel 113. The light beam L is emitted from the display surface 113a toward each direction. The display device 100 may include this display unit 150 and the above-mentioned sensor 120 and control unit 130.

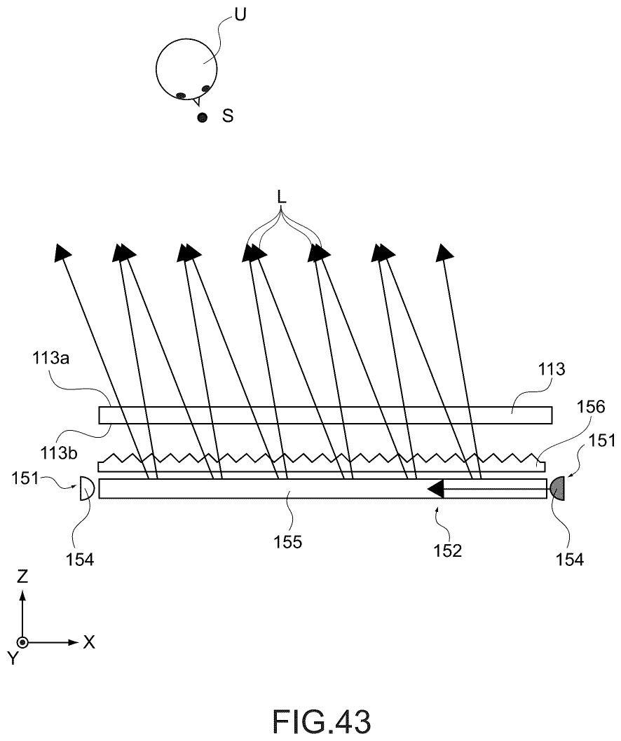

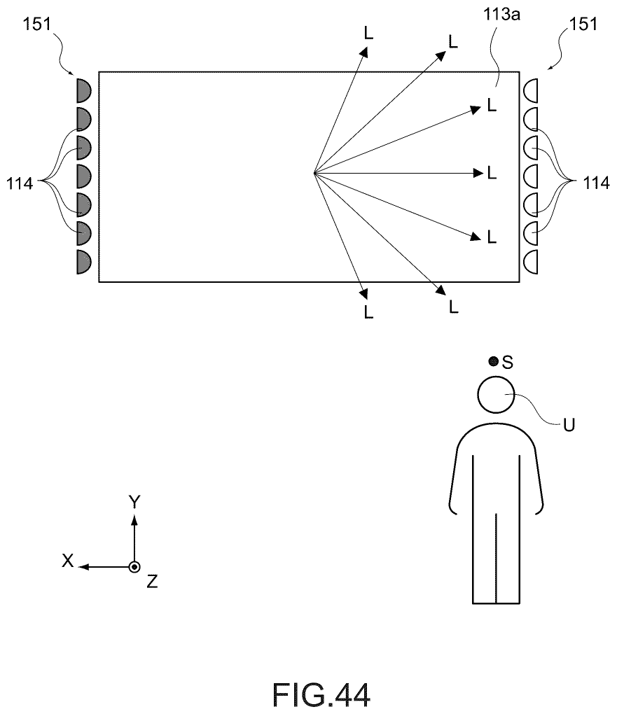

FIG. 43 to FIG. 46 are each a schematic diagram showing an operation of the display device 100 including the backlight 151. As shown in FIG. 43, in the case where there is a viewer U facing the display surface 113a, the light emission control unit 132 causes a light-emitting unit 154a that is a light source of the light beam L emitted from the display surface 113a toward the viewer position S to emit light and turns off or dims the other light-emitting units 154. In this configuration, the light-emitting unit 154a is the light-emitting unit 154 that is located on the side opposite to the viewer U. As a result, as shown in FIG. 44, when the display surface 113a is viewed from the viewer U, the light beam L that is transmitted through the display panel 113 toward the viewer position S is visible and the video displayed on the display surface 113a can be viewed in the same manner as in a general display. Meanwhile, since the other light-emitting units 114 are turned off, it is possible to reduce power consumption of the display panel 113.

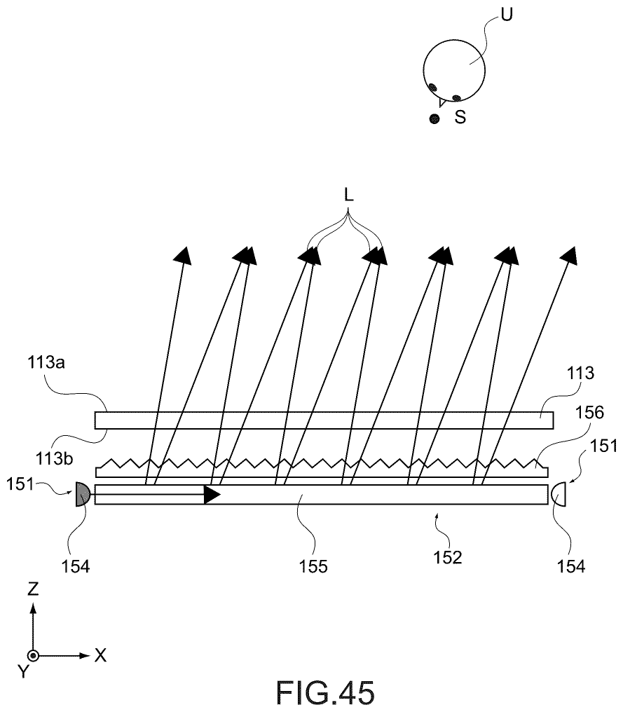

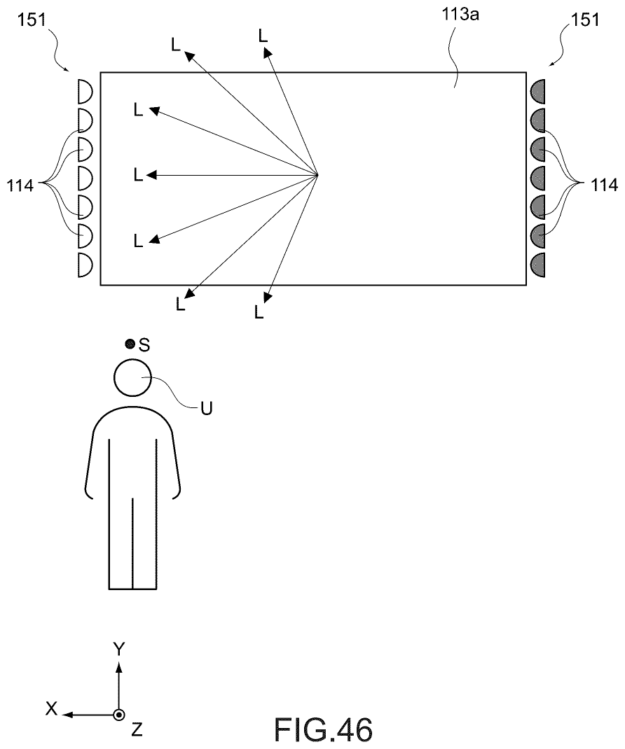

In the case where the viewer U is present at the position shown in FIG. 45, the light-emitting unit 154 that is caused to emit light by the light emission control unit 132 is on the side opposite to that in FIG. 43. Also in this case, as shown in FIG. 46, when the display surface 113a is viewed from the viewer U, the light beam L that is transmitted through the display panel 113 toward the viewer position S is visible and the video displayed on the display surface 113a can be viewed in the same manner as in a general display. As described above, even in the display unit 150 including the edge backlight 151, it is possible to reduce power consumption while maintaining the visibility of displayed video. In the case of the edge backlight 151, the emission direction of the light beam L cannot be controlled as precisely as with the direct backlight 111, but it is possible to reduce power consumption with simple control. Further, the edge backlight 151 is suitable for making the display unit 150 thinner.

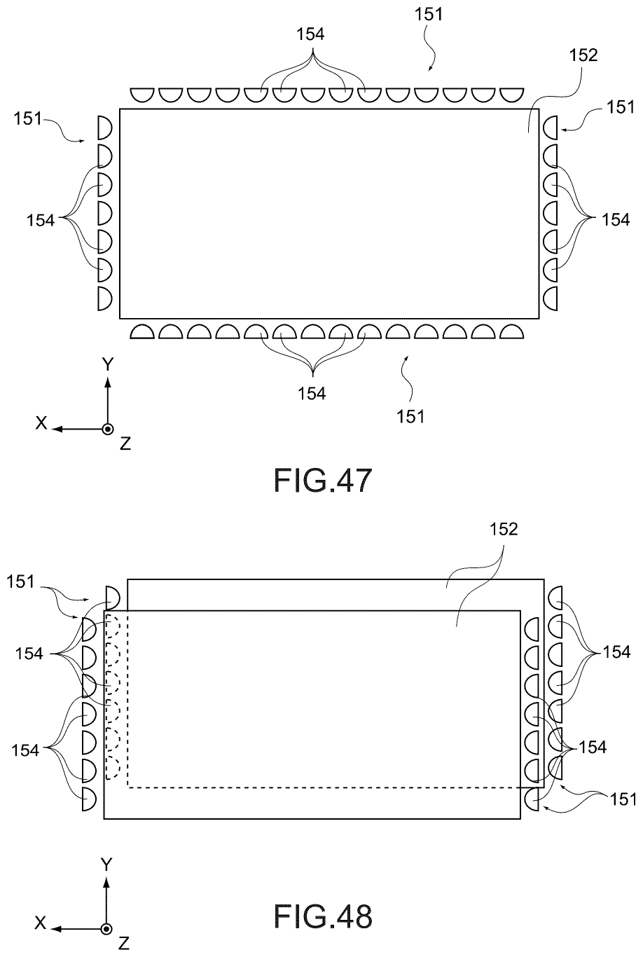

FIG. 47 and FIG. 48 are each a schematic diagram showing another configuration of the edge backlight 151. As shown in FIG. 47, in the edge backlight 151, the light-emitting unit 154 may be disposed above and below the light beam control unit 152. In this case, the emission direction of the light beam L can be controlled in four directions, up, down, right, and left. Further, as shown in FIG. 48, the edge backlight 151 and the light beam control unit 152 may each include two layers. In this case, since the light emitted from the backlight 151 on the side farther from the display panel 113 passes through the two light beam control units 152, the incidence angle on the light-incident surface 113b is different from that of the light emitted from the backlight 151 on the side closer to the display panel 113. Therefore, in this configuration, the emission direction of the light beam L can be controlled in two directions at the right and left, i.e., a total of four directions. Further, the number of the above layers is not limited to two and may be three or more.

### [Hardware Configuration of Control Unit]

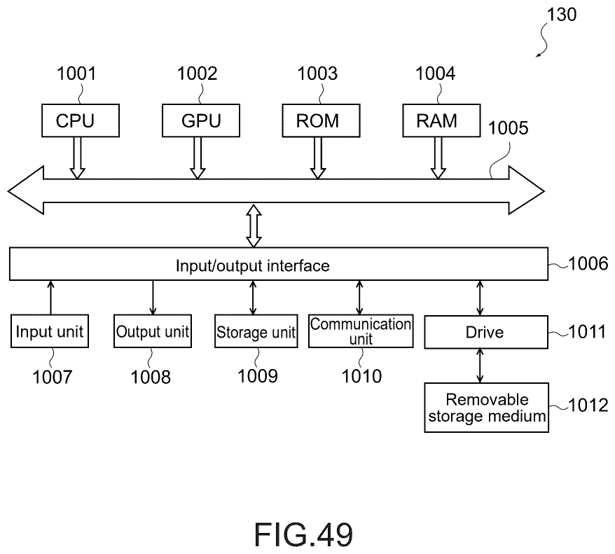

A hardware configuration capable of realizing the functional configuration of the control unit 130 will be described. FIG. 49 is a schematic diagram showing this hardware configuration.

As shown in the figure, the control unit 130 includes a CPU (Central Processing Unit) 1001 and a GPU (Graphics Processing Unit) 1002 therein. An input/output interface 1006 is connected to the CPU 1001 and the GPU 1002 via a bus 1005. A ROM (Read Only Memory) 1003 and a RAM (Random Access Memory) 1004 are connected to the bus 1005.

An input unit 1007 that includes an input device such as a keyboard and a mouse for a user to input an operation command, an output unit 1008 that outputs a processing operation screen and an image of a processing result to a display device, a storage unit 1009 that includes a hard disk drive or the like for storing a program and various types of data, and a communication unit 1010 that includes a LAN (Local Area Network) adapter or the like and executes communication processing via a network typified by the Internet are connected to the input/output interface 1006. Further, a drive 1011 that reads and writes data from/to a removable storage medium 1012 such as a magnetic disc, an optical disc, a magneto-optical disc, and a semiconductor memory is connected.

The CPU 1001 executes various types of processing in accordance with a program stored in the ROM 1003 or a program that is read from the removable storage medium 1012 such as a magnetic disc, an optical disc, a magneto-optical disc, and a semiconductor memory, installed in the storage unit 1009, and loaded from the storage unit 1009 into the RAM 1004. The RAM 1004 also stores data and the like necessary for the CPU 1001 to execute various types of processing, as appropriate. The GPU 1002 executes calculation processing necessary for image rendering upon receiving control of the CPU 1001.

In the control unit 130 configured as described above, for example, the CPU 1001 loads a program stored in the storage unit 1009 into the RAM 1004 via the input/output interface 1006 and the bus 1005, thereby performing the above-mentioned series of processes.

The program executed by the control unit 130 can be stored in, for example, the removable storage medium 1012 as a package medium and provided. Further, the program can be provided via a wired or wireless transmission medium such as a local area network, the Internet, and digital satellite broadcasting.

In the control unit 130, the program can be installed in the storage unit 1009 via the input/output interface 1006 by mounting the removable storage medium 1012 in the drive 1011. Further, the program can be received by the communication unit 1010 via a wired or wireless transmission medium and installed in the storage unit 1009. In addition, the program can be installed in the ROM 1003 or the storage unit 1009 in advance.

Note that the program executed by the control unit 130 may be a program by which processing is performed in chronological order in the order described in the present disclosure or may be a program by which processing is performed in parallel or necessary timing such as when called. Further, all the hardware configurations of the control unit 130 do not necessarily need to be mounted on one device, and a plurality of device may constitute the control unit 130. Further, it may be mounted on part of the hardware configuration of the control unit 130 or a plurality of devices connected via a network.

### Regarding Present Disclosure

The effects described in the present disclosure are merely examples and are not limited, and other effects may be achieved. The above description of the plurality of effects does not necessarily mean that these effects are exhibited simultaneously. It means that at least one of the effects described above can be achieved in accordance with the conditions or the like, and there is a possibility that an effect that is not described in the present disclosure is exhibited. Further, at least two feature portions of the feature portions described in the present disclosure may be combined.

It should be noted that the present technology may also take the following configurations.

(1) A display device, including:
a backlight that includes a plurality of light-emitting units;
a light beam control unit that controls light that has entered from each of the plurality of light-emitting units to travel in a direction corresponding to a position of the light-emitting unit that is a light source and emits the light;
a display panel that has a display surface, the light that has entered from the light beam control unit being transmitted through the display panel and emitted from the display surface;
a viewer position recognition unit that recognizes a viewer position that is a position of a viewer with respect to the display surface; and
a light emission control unit that controls each of the light-emitting units on a basis of a direction in which light from each of the light-emitting units as a light source is emitted from the display surface and the viewer position.

(2) The display device according to (1) above, in which
the light emission control unit causes a light-emitting unit that is a light source of light emitted from the display surface toward the viewer position, of the plurality of light-emitting units, to emit light and dims or turns off a light-emitting unit that is a light source of light emitted from the display surface to a direction different from the viewer position.

(3) The display device according to (1) or (2) above, in which
the light beam control unit controls, in a control direction that is a direction parallel to the display surface, a direction in which light that has entered from each of the light-emitting units travels, and
the light emission control unit controls each of the light-emitting units in accordance with a position of each of the light-emitting units in the control direction relative to the light beam control unit.

(4) The display device according to (3) above, in which
the light beam control unit is a lens that has a curvature in the control direction.

(5) The display device according to (4) above, in which
the control direction is all directions parallel to the display surface, and
the light beam control unit is a lens array that includes a lens having a curvature in the all directions.

(6) The display device according to (4) above, in which
the control direction is one direction parallel to the display surface, and
the light beam control unit is a lens array that includes a lens having a curvature in the one direction.

(7) The display device according to any one of (1) to (6) above, in which
the backlight is a direct backlight in which the plurality of light-emitting units faces a surface of the display panel opposite to the display surface, and
the light beam control unit is disposed between the backlight and the display panel.

(8) The display device according to any one of (1) to (6) above, in which
the backlight includes backlights that are edge backlights in which the plurality of light-emitting units is arranged along a peripheral edge of the display panel, and
the light beam control unit is disposed between the backlights.

(9) The display device according to any one of (1) to (8) above, further including
a video generation unit that generates video to be displayed on the display surface,
the light emission control unit controlling each of the light-emitting units in accordance with brightness of each region of the video and controlling each of the light-emitting units on a basis of the emission direction and the viewer position.

(10) The display device according to any one of (1) to (8) above, further including
a video generation unit that generates video to be displayed on the display surface,
the video generation unit correcting the video in accordance with the viewer position and a control state of each of the light-emitting units by the light emission control unit.

(11) The display device according to any one of (1) to (10) above, in which
the light emission control unit controls, when the viewer position is equal to or less than a certain number, each of the light-emitting units on a basis of the emission direction and the viewer position, and causes, when the viewer position exceeds the certain number, all of the plurality of light-emitting units to emit light.

(12) The display device according to any one of (1) to (11) above, further including
a sensor that detects a viewer facing the display surface,
the viewer position recognition unit recognizing the viewer position on a basis of a detection result of the sensor.

(13) The display device according to (12) above, in which
the sensor tracks a face or an eye of the viewer facing the display surface, and
the viewer position recognition unit recognizes the viewer position on a basis of a result of the tracking.

(14) The display device according to (13) above, in which
the sensor tracks a line of sight of the viewer facing the display surface, and
the viewer position recognition unit does not recognize, when the line of sight is not directed toward the display surface, a position of the viewer as the viewer position.

(15) The display device according to (14) above, in which
the sensor identifies the viewer facing the display surface, and
the light emission control unit does not recognize, when the viewer facing the display surface is not a viewer registered in advance, a position of the viewer as the viewer position.

(16) The display device according to (12) above, in which
the sensor detects the viewer facing the display surface using a temperature, infrared rays, sound, or a radio wave.

(17) The display device according to any one of (1) to (16) above, in which
the light emission control unit causes, when the viewer position is not recognized by the viewer position recognition unit, a light-emitting unit that is a light source of light emitted from the display surface toward an outermost side, of the plurality of light-emitting units, to emit light and dims or turns off a light-emitting unit that is a light source of light emitted from the display surface to a direction that is not the outermost side.

(18) The display device according to any one of (1) to (16) above, in which
the light emission control unit causes, when the viewer position is not recognized by the viewer position recognition unit, a light-emitting unit that is a light source of light emitted from the display surface toward the viewer position and a light-emitting unit that is a light source of light emitted from the display surface toward the outermost side to emit light and dims or turns off a light-emitting unit that is a light source of light emitted from the display surface to a direction that is different from the viewer position and is not the outermost side.

(19) A program that causes a display device to operate as:
a viewer position recognition unit that recognizes a viewer position that is a position of a viewer relative to a display surface of a display panel; and
a light emission control unit that controls each of a plurality of light-emitting units included in a backlight on a basis of a direction in which light from each of the light-emitting units as a light source is emitted from the display surface and the viewer position, each of the light-emitting units emitting light that enters a light beam control unit from each of the light-emitting units, is controlled to travel in a direction corresponding to a light-emitting unit that is a light source and be emitted, and is transmitted through the display panel and emitted from the display surface.

(20) A control method for a display device, including:
recognizing a viewer position that is a position of a viewer relative to a display surface of a display panel; and
controlling each of a plurality of light-emitting units included in a backlight on a basis of a direction in which light from each of the light-emitting units as a light source is emitted from the display surface and the viewer position, each of the light-emitting units emitting light that enters a light beam control unit from each of the light-emitting units, is controlled to travel in a direction corresponding to a light-emitting unit that is a light source and be emitted, and is transmitted through the display panel and emitted from the display surface.

### REFERENCE SIGNS LIST

100 display device
110 display unit
111 backlight
112 light beam control unit
113 display panel
114 light-emitting unit
115 lens
116 light-emitting region
120 sensor
130 control unit
131 viewer position recognition unit
132 light emission control unit
133 video generation unit
150 display unit
151 backlight
152 light beam control unit
154 light-emitting unit
155 light guide plate
156 reflection structure

1. A display device, comprising:
a backlight that includes a plurality of light-emitting units;
a light beam control unit that controls light that has entered from each of the plurality of light-emitting units to travel in a direction corresponding to a position of the light-emitting unit that is a light source and emits the light;
a display panel that has a display surface, the light that has entered from the light beam control unit being transmitted through the display panel and emitted from the display surface;
a viewer position recognition unit that recognizes a viewer position that is a position of a viewer with respect to the display surface; and
a light emission control unit that controls each of the light-emitting units on a basis of a direction in which light from each of the light-emitting units as a light source is emitted from the display surface and the viewer position.

2. The display device according to claim 1, wherein
the light emission control unit causes a light-emitting unit that is a light source of light emitted from the display surface toward the viewer position, of the plurality of light-emitting units, to emit light and dims or turns off a light-emitting unit that is a light source of light emitted from the display surface to a direction different from the viewer position.

3. The display device according to claim 1, wherein
the light beam control unit controls, in a control direction that is a direction parallel to the display surface, a direction in which light that has entered from each of the light-emitting units travels, and
the light emission control unit controls each of the light-emitting units in accordance with a position of each of the light-emitting units in the control direction relative to the light beam control unit.

4. The display device according to claim 3, wherein
the light beam control unit is a lens that has a curvature in the control direction.

5. The display device according to claim 4, wherein
the control direction is all directions parallel to the display surface, and
the light beam control unit is a lens array that includes a lens having a curvature in the all directions.

6. The display device according to claim 4, wherein
the control direction is one direction parallel to the display surface, and
the light beam control unit is a lens array that includes a lens having a curvature in the one direction.

7. The display device according to claim 1, wherein
the backlight is a direct backlight in which the plurality of light-emitting units faces a surface of the display panel opposite to the display surface, and
the light beam control unit is disposed between the backlight and the display panel.

8. The display device according to claim 1, wherein
the backlight includes backlights that are edge backlights in which the plurality of light-emitting units is arranged along a peripheral edge of the display panel, and
the light beam control unit is disposed between the backlights.

9. The display device according to claim 1, further comprising
a video generation unit that generates video to be displayed on the display surface,
the light emission control unit controlling each of the light-emitting units in accordance with brightness of each region of the video and controlling each of the light-emitting units on a basis of the emission direction and the viewer position.

10. The display device according to claim 1, further comprising
a video generation unit that generates video to be displayed on the display surface,
the video generation unit correcting the video in accordance with the viewer position and a control state of each of the light-emitting units by the light emission control unit.

11. The display device according to claim 1, wherein
the light emission control unit controls, when the viewer position is equal to or less than a certain number, each of the light-emitting units on a basis of the emission direction and the viewer position, and causes, when the viewer position exceeds the certain number, all of the plurality of light-emitting units to emit light.

12. The display device according to claim 1, further comprising
a sensor that detects a viewer facing the display surface,
the viewer position recognition unit recognizing the viewer position on a basis of a detection result of the sensor.

13. The display device according to claim 12, wherein
the sensor tracks a face or an eye of the viewer facing the display surface, and
the viewer position recognition unit recognizes the viewer position on a basis of a result of the tracking.

14. The display device according to claim 13, wherein
the sensor tracks a line of sight of the viewer facing the display surface, and
the viewer position recognition unit does not recognize, when the line of sight is not directed toward the display surface, a position of the viewer as the viewer position.

15. The display device according to claim 13, wherein
the sensor identifies the viewer facing the display surface, and
the light emission control unit does not recognize, when the viewer facing the display surface is not a viewer registered in advance, a position of the viewer as the viewer position.

16. The display device according to claim 12, wherein
the sensor detects the viewer facing the display surface using a temperature, infrared rays, sound, or a radio wave.

17. The display device according to claim 1, wherein
the light emission control unit causes, when the viewer position is not recognized by the viewer position recognition unit, a light-emitting unit that is a light source of light emitted from the display surface toward an outermost side, of the plurality of light-emitting units, to emit light and dims or turns off a light-emitting unit that is a light source of light emitted from the display surface to a direction that is not the outermost side.

18. The display device according to claim 1, wherein
the light emission control unit causes, when the viewer position is not recognized by the viewer position recognition unit, a light-emitting unit that is a light source of light emitted from the display surface toward the viewer position and a light-emitting unit that is a light source of light emitted from the display surface toward the outermost side to emit light and dims or turns off a light-emitting unit that is a light source of light emitted from the display surface to a direction that is different from the viewer position and is not the outermost side.

19. A program that causes a display device to operate as:
a viewer position recognition unit that recognizes a viewer position that is a position of a viewer relative to a display surface of a display panel; and
a light emission control unit that controls each of a plurality of light-emitting units included in a backlight on a basis of a direction in which light from each of the light-emitting units as a light source is emitted from the display surface and the viewer position, each of the light-emitting units emitting light that enters a light beam control unit from each of the light-emitting units, is controlled to travel in a direction corresponding to a light-emitting unit that is a light source and be emitted, and is transmitted through the display panel and emitted from the display surface.

20. A control method for a display device, comprising:
recognizing a viewer position that is a position of a viewer relative to a display surface of a display panel; and
controlling each of a plurality of light-emitting units included in a backlight on a basis of a direction in which light from each of the light-emitting units as a light source is emitted from the display surface and the viewer position, each of the light-emitting units emitting light that enters a light beam control unit from each of the light-emitting units, is controlled to travel in a direction corresponding to a light-emitting unit that is a light source and be emitted, and is transmitted through the display panel and emitted from the display surface.
